(19) United States
(12) Patent Application Publication
(10) Pub. No.: US 2017/0241786 A1
(43) Pub. Date: Aug. 24, 2017

(54) ESTIMATION DEVICE, ESTIMATION METHOD, AND NON-TRANSITORY COMPUTER READABLE STORAGE MEDIUM

(71) Applicant: YAHOO JAPAN CORPORATION, Tokyo (JP)

(72) Inventors: Yuki OHIRA, Tokyo (JP); Munehiro AZAMI, Tokyo (JP)

(73) Assignee: YAHOO JAPAN CORPORATION, Tokyo (JP)

(21) Appl. No.: 15/376,433

(22) Filed: Dec. 12, 2016

(30) Foreign Application Priority Data
Feb. 19, 2016 (JP) 2016-030296

(51) Int. Cl. G01C 21/16; G01P 7/00; G01C 21/34

(52) U.S. Cl. CPC G01C 21/16; G01C 21/34; G01P 7/00

(57) ABSTRACT

According to one aspect of an embodiment an estimation device includes a detection unit that detects a predetermined physical state that is produced at a time of movement. The estimation device includes an estimation unit that estimates a moving velocity from a state detected by the detection unit, by using a learner that has learned a velocity zone with the physical state being produced therefrom.

### CROSS-REFERENCE TO RELATED APPLICATION

The present application claims priority to and incorporates by reference the entire contents of Japanese Patent Application No. 2016-030296 filed in Japan on Feb. 19, 2016.

### BACKGROUND OF THE INVENTION

1. Field of the Invention

The present invention relates to an estimation device, an estimation method, and a non-transitory computer readable storage medium.

2. Description of the Related Art

A car navigation (that may be referred to as “guiding”, below) technique has conventionally been known that guides a car with a user getting thereon to a destination by using a portable terminal device such as a smartphone. Such a terminal device that executes guiding identifies a current place of a car by using a satellite positioning system such as a Global Positioning System (GPS) and displays the identified current place that is superimposed on a screen that indicates a map and a guiding route.

On the other hand, it may be impossible for a terminal device to display a current place on a place where it is difficult to receive a signal from a satellite, such as an inside of a tunnel. A similar problem is common to the whole of positioning that uses an external signal (for example, radio waves from a base station for a mobile (cellular) phone, radio waves for a wireless LAN, or the like) as well as a GPS. Hence, it is possible to consider an autonomous positioning technique that estimates a current place of a car by using acceleration that is measured by an accelerometer. For example, a method has been proposed that fixes a device that includes an accelerometer, at a predetermined attitude thereof, in a car, and determines a moving state of the car from acceleration detected by the device.

Patent Document 1: Japanese Laid-open Patent Publication No. H11-248455

Patent Document 2: Japanese Patent No. 4736866

However, it may be impossible for a conventional technique as described above to estimate a moving velocity of a car accurately.

For example, in a conventional technique as described above, values of acceleration measured by a terminal device are integrated to estimate a velocity of a car. However, a value of acceleration to be measured is changed depending on a moving state of a car or an installation attitude of a terminal device, and hence, accuracy of estimation of a moving velocity may be degraded.

### SUMMARY OF THE INVENTION

It is an object of the present invention to at least partially solve the problems in the conventional technology.

According to one aspect of an embodiment an estimation device includes a detection unit that detects a predetermined physical state that is produced at a time of movement. The estimation device includes an estimation unit that estimates a moving velocity from a state detected by the detection unit, by using a learner that has learned a velocity zone with the physical state being produced therefrom.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an action and an effect that are exerted by a terminal device according to an embodiment;

FIG. 2 is a diagram illustrating an example of a functional configuration that is included in a terminal device according to an embodiment;

FIG. 3 is a diagram illustrating an example of information that is registered in a learning data database according to an embodiment;

FIG. 4 is a diagram illustrating an example of information that is registered in an estimated velocity data database according to an embodiment;

FIG. 5 is a diagram illustrating an example of information that is registered in a model data database according to an embodiment;

FIG. 6 is a flowchart illustrating an example of a flow of a guiding process that is executed by a terminal device according to an embodiment;

FIG. 7 is a flowchart illustrating an example of a flow of an acquisition process that is executed by a terminal device according to an embodiment;

FIG. 8 is a flowchart illustrating an example of a flow of an estimation process that is executed by a terminal device according to an embodiment;

FIG. 9 is a flowchart illustrating an example of a flow of a process of estimating a moving velocity in a terminal device according to an embodiment;

FIG. 10 is a flowchart illustrating an example of a flow of a process of collecting learning data in a terminal device according to an embodiment;

FIG. 11 is a flowchart illustrating an example of a flow of a process of learning a model in a terminal device according to an embodiment;

FIG. 12 is a first diagram illustrating a variation of a model that is used in a terminal device according to an embodiment;

FIG. 13 is a second diagram illustrating a variation of a model that is used in a terminal device according to an embodiment; and

FIG. 14 is a third diagram illustrating a variation of a model that is used in a terminal device according to an embodiment.

### DETAILED DESCRIPTION OF THE PREFERRED EMBODIMENTS

Hereinafter, a mode for implementing an estimation device, an estimation method, and non-transitory computer readable storage medium according to the present application (that will be referred to as an “embodiment”, below) will be described in detail, with reference to the drawings. An estimation device, an estimation method, and non-transitory computer readable storage medium according to the present application are not limited by such an embodiment. In each embodiment as provided below, an identical site and process will be provided with an identical symbol and a redundant description thereof will be omitted.

In the following description, an example of a process of estimating a moving velocity of a car with a user getting thereon in car navigation for guiding the car to a destination will be described as a process that is executed by an estimation device, and an embodiment is not limited thereto. For example, an estimation device may execute a process as described below and execute a process of guiding a user to a destination, even in a case where the user walks or a case where a means of transportation other than a car, such as a train, is utilized. That is, any mode of an embodiment is applicable, as long as a process is to estimate a moving velocity of an object (that will be described as a “movable body”, below) that is a target for estimation of the moving velocity.

1. Outline of Moving State

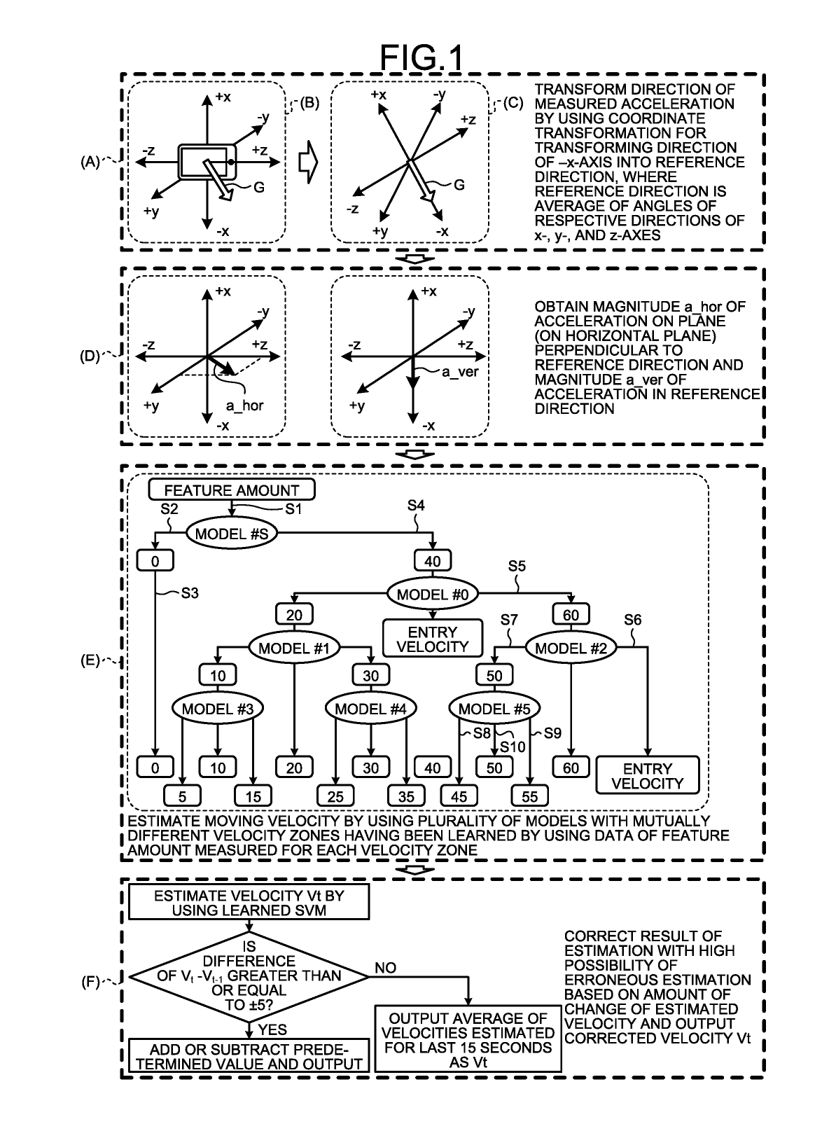

First, a concept of a movement mode that is determined by a terminal device 10 that is an example of an estimation device will be described by using FIG. 1. FIG. 1 is a diagram illustrating an example of an action and an effect that are exerted by a terminal device according to an embodiment. For example, the terminal device 10 is a terminal device such as a mobile terminal such as a smartphone, a tablet terminal, or a Personal Digital Assistant (PDA), or a notebook-size Personal Computer (PC), where the terminal device is communicable with any server through a network N such as a mobile communication network or a wireless Local Area Network (LAN).

The terminal device 10 has a function of car navigation for guiding a car with a user getting thereon to a destination. For example, the terminal device 10 accepts input of a destination from a user, and then, acquires route information for guiding the user to the destination from a server or the like with omitted illustration thereof. For example, route information includes data such as a route to a destination with a car being available thereon, information of an expressway that is included in the route, information of a traffic jam on the route, a facility that is a landmark for guiding, information of a map that is displayed on a screen, a sound that is output at a time of guiding, or an image such as a map.

The terminal device 10 has a positioning function that identifies a position of the terminal device 10 (that will be described as a “current place”, below) at a predetermined time interval by using a satellite positioning system such as a Global Positioning System (GPS). The terminal device 10 displays an image such as a map that is included in route information on a liquid crystal screen, an electroluminescence or Light Emitting Diode (LED) screen, or the like (that will simply be described as a “screen”, below) and displays the identified current place on the map accordingly. The terminal device 10 displays a left turn or a right turn, a change of a lane to be used, expected arrival time to a destination, or the like, or outputs sound thereof from the terminal device 10, a speaker of a car, or the like, depending on the identified current place.

A satellite positioning system receives a signal transmitted from a plurality of satellites and identifies a current place of the terminal device 10 by using the received signal. Hence, it may be impossible for the terminal device 10 to identify a current place thereof, in a case where it may be impossible to receive a signal transmitted from a satellite appropriately in a tunnel, a place interposed by buildings, or the like. An application or the like that causes the terminal device 10 to realize guiding does not include a function of acquiring information such as a velocity or a moving direction from a car. Hence, it is possible to consider a method of installing an acceleration sensor that measures acceleration, in the terminal device 10, and estimating a current position of the terminal device 10 based on acceleration measured by the acceleration sensor. For example, it is possible to consider a method of executing stop determination for determining whether the terminal device 10 is moving or stops, based on acceleration measured by an acceleration sensor.

A more specific example will be described. For example, the terminal device 10 determines that a car enter a tunnel or the like in a case where it may be impossible to receive a signal transmitted from a satellite appropriately, and moves forward on an estimated position with a last identified speed and traveling direction of a car. The terminal device 10 determines whether or not a car stops, based on the measured acceleration, and stops movement of an estimated position in a case where it is determined that a car stops. On the other hand, in a case where it is determined that a car does not stop, the terminal device 10 estimates a moving velocity of a car that is a movable body, by using the measured acceleration, and continues guiding while movement at the estimated moving velocity is assumed.

1.1 Example of Velocity Estimation Technique

Herein, an example of a velocity estimation technique for estimating a moving velocity of a car will be described. A technique as described herein is an example of a technique that is provided at a preliminary step toward the present invention and does not belong to a proper conventional technique. That is, a technique as described herein is a technique that is secretly implemented by the present applicant for development, testing, research, or the like, and is not a technique that has escaped from a secret, such as so-called publicly known one, publicly used one, or publicly known one by literature.

For example, the terminal device 10 measures acceleration in a direction of each of x-, y-, and z-axes, where an x-axis is provided in a direction of a short side of a screen, a y-axis is provided in a direction of a long side of the screen, and a z-axis is provided in a direction perpendicular to the screen. For example, the terminal device 10 measures acceleration in a terminal coordinate system where a screen is a front face, a front face side is provided in a direction of a +z axis, a back face side is provided in a direction of a −z axis, an upper side of the screen is provided in a direction of a +x axis, a lower side of the screen is provided in a direction of a −x axis, a left side of the screen is provided in a direction of a +y axis, and a right side of the screen is provided in a direction of a −y axis, at a time of utilization of the terminal device 10.

On the other hand, a moving direction or a velocity of a car that is used by a user is represented by a car coordinate system where a Z-axis is provided in a traveling direction of the car, a direction of a Y-axis on a plane perpendicular to the Z-axis is a direction of a left turn or a right turn in a case where the car travels, and a direction of an X-axis is an upward or downward direction of the car. For example, a moving direction or a velocity of a car is represented by a car coordinate system where an upward direction of the car is a direction of a +X-axis, a downward direction thereof (that is, a ground surface side) is a direction of a −X-axis, a direction of a left turn is a direction of a +Y-axis, a direction of a right turn is a direction of a −Y-axis, a backward direction of the car is a direction of a +Z-axis, and a frontward direction thereof is a direction of a −Z-axis. Herein, a car coordinate system and a terminal coordinate system have a difference dependent on an installation attitude or the like of the terminal device 10.

Hence, for example, the terminal device 10 estimates a direction of force of gravity, that is, a direction of a −X-axis of a car coordinate system, by using acceleration measured in a terminal coordinate system, identifies a traveling direction of a car by using dispersion of acceleration that is produced in a case where the car accelerates or changes the traveling direction, and obtains a rotation matrix for transforming acceleration measured in the terminal coordinate system into that in the car coordinate system, based on such an estimated reference direction and traveling direction. The terminal device 10 transforms acceleration in a terminal coordinate system into acceleration in a car coordinate system by using a rotation matrix, and executes stop determination as to whether or not a car stops or estimation of a moving velocity of a car, by using acceleration after such transformation.

For example, the terminal device 10 collects, as feature amounts, total 18 pieces of information that are amplitude, frequencies, averages, standard deviations, maximums, and minimums of acceleration after transformation in directions of respective axis. The terminal device 10 accumulates, as a feature amount during running, a feature amount acquired in a case where a velocity of a car is greater than or equal to a predetermined threshold, and accumulates, as a feature amount during a stop, a feature amount acquired in a case where a velocity of a car is less than or equal to a predetermined threshold. The terminal device 10 learns a stop determination model for determining whether or not a car stops (based on, for example, a Support Vector Machine (SVM) as described later) by using the accumulated feature amount, and determines whether or not a car stops by using the learned stop determination model in a case where it may be impossible to use a satellite positioning system, such as a tunnel or the like. In a case where it is determined that a car does not stop, the terminal device 10 estimates a moving velocity of a car based on a value of integral of values of acceleration on a plane that includes a traveling direction, among acceleration acquired in a car coordinate system.

However, such a technique has a problem in that it may be difficult to align a car coordinate system with a terminal coordinate system accurately due to a factor such as a slope, a corner, or the like of a road, and hence, it may be difficult to estimate a moving velocity of a car from the measured acceleration accurately.

A user may get off a car at a service area or the like while the terminal device 10 is carried. As a result, a rotation matrix is changed in a case where an attitude of the terminal device 10 is changed, and hence, it may be necessary to identify a traveling direction again and obtain a rotation matrix again based on the identified traveling direction and a reference direction. However, even in a case where such a process is executed, it may be impossible to execute stop determination of a car or estimate a moving velocity of a car until a traveling direction is identified. In a case where a road is sloped, a case where a traveling direction is changed at a corner or the like, or the like, it may be possible to cause a difference between a terminal coordinate system and a car coordinate system, and hence, an error is readily caused in a result of determination or a moving velocity of a car.

2. For Estimation Process to be Executed by Terminal Device 10 According to Embodiment

The terminal device 10 executes an estimation process as described below. For example, the terminal device 10 detects a physical state that is produced in a case where a car moves. The terminal device 10 estimates a moving velocity from the detected physical state by using a learner that has learned a velocity zone with a physical state being produced therefrom.

Hereinafter, an example of a functional configuration, an action, and an effect of the terminal device 10 that realizes an estimation process as described above will be described by using the drawings.

2-1. Example of Functional Configuration

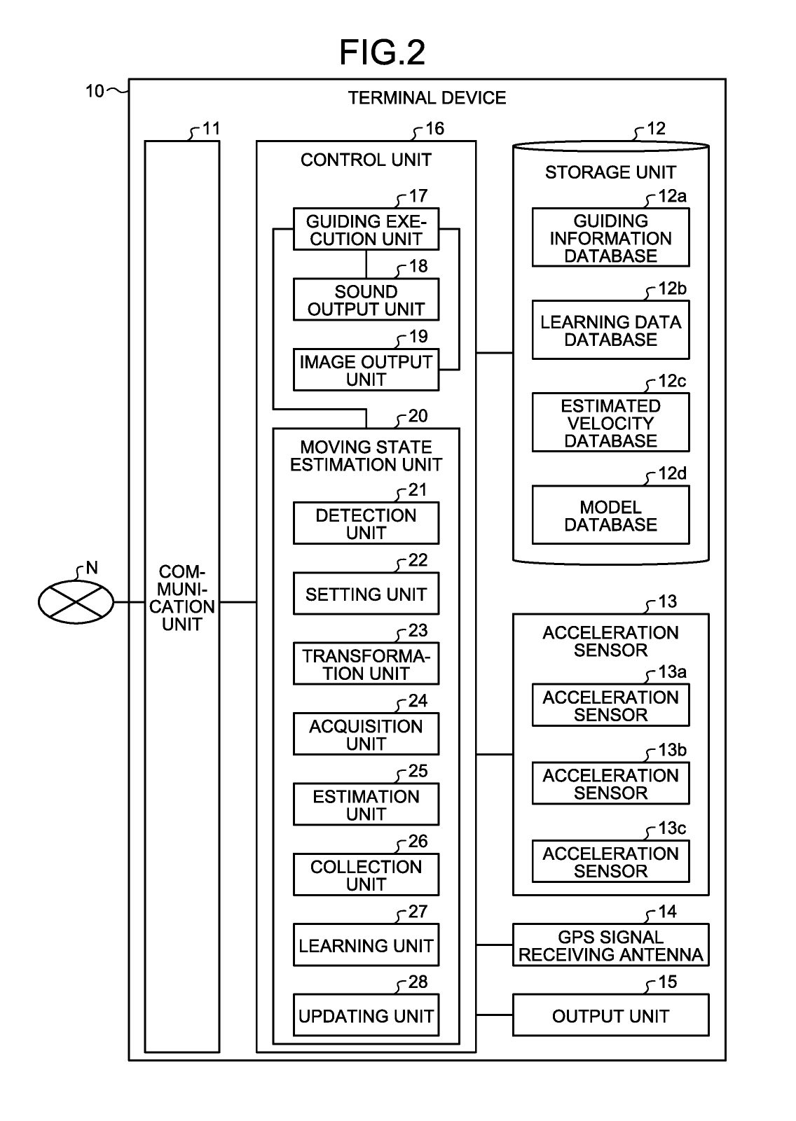

FIG. 2 is a diagram illustrating an example of a functional configuration that is included in a terminal device according to an embodiment. As illustrated in FIG. 2, the terminal device 10 includes a communication unit 11, a storage unit 12, a plurality of acceleration sensors 13a to 13c (that may collectively be described as an “acceleration sensor 13”, below), a GPS signal receiving antenna 14, an output unit 15, and a control unit 16. The communication unit 11 is realized by, for example, a Network Interface Card (NIC) or the like. The communication unit 11 is wired- or wireless-connected to a network N, and as a signal of a destination is received from the terminal device 10, transmission or receiving of a signal of information is executed between the terminal device 10 and a distribution server that distributes route information that indicates a route to the destination.

The storage unit 12 is realized by, for example, a semiconductor memory element such as a Random Access Memory (RAM) or a Flash Memory, or a storage device such as a hard disk or an optical disk. The storage unit 12 includes a guiding information database 12a that is a variety of data to be used for executing guiding, a learning data database 12b, an estimated velocity database 12c, and a model database 12d.

In the guiding information database 12a, a variety of data that are used in a case where the terminal device 10 executes guiding are registered. For example, information of a route to a destination received from a server or the like with omitted illustration thereof is stored in the guiding information database 12a. A variety of images or sound data or the like that are output for guiding are also stored in the guiding information database 12a.

In the learning data database 12b, learning data that are used for learning of a stop determination model and a velocity estimation model are registered. Specifically, a predetermined number of learning data with a collected feature amount being associated with a moving velocity in a case where such a feature amount is collected, are registered, for each velocity zone that includes a moving velocity of the terminal device 10, in the learning data database 12b.

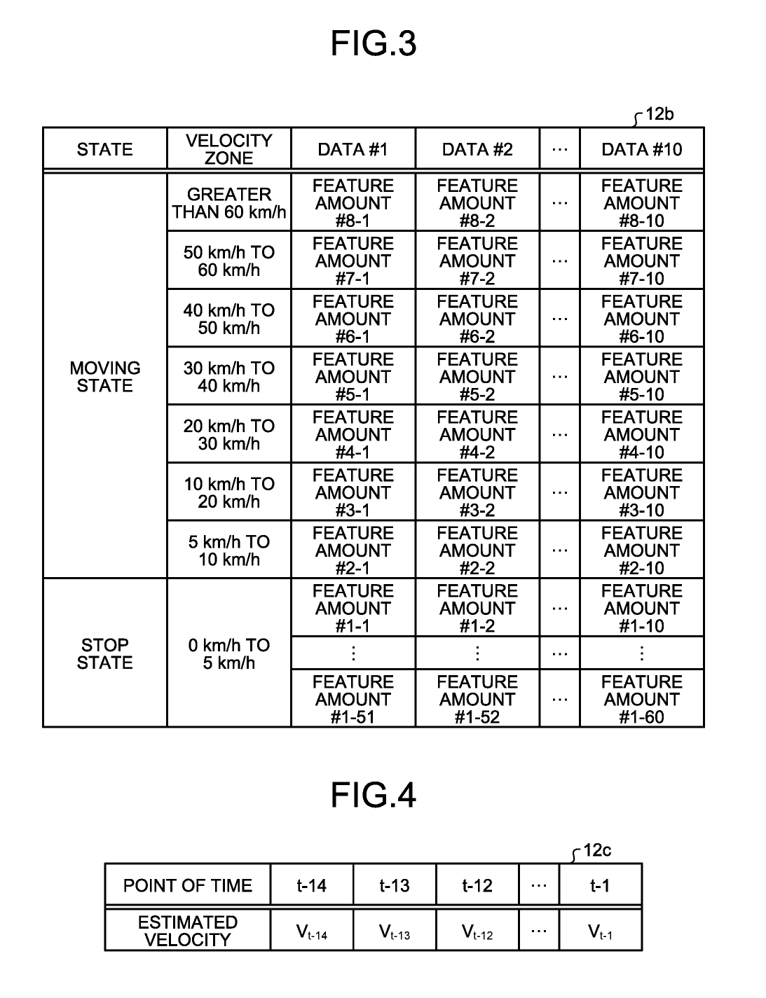

For example, FIG. 3 is a diagram illustrating an example of information that is registered in a learning data database according to an embodiment. As illustrated in FIG. 3, information that has items such as a “STATE”, a “VELOCITY ZONE”, and “DATA #1” to “DATA #10” is registered in the learning data database 12b. Herein, a “STATE” is information that indicates whether associated learning data are data that indicate a moving state or data that indicate a stop state. A “VELOCITY ZONE” is information that indicates a velocity zone with a moving velocity of the terminal device 10 in a case where an associated feature amount is acquired belonging thereto. “DATA #1” to “DATA #2” are sets of a feature amount and a moving velocity in a case where such a feature amount is collected, that is, learning data.

For example, in an example as illustrated in FIG. 3, data of feature amount that are a “FEATURE AMOUNT #1-1” to a “FEATURE AMOUNT #1-60” that are collected in a case where a moving velocity of the terminal device 10 is “0 km/h (kilometers per hour)-5 km/h” are registered as learning data that indicate a “stop state” in the learning data database 12b. In the learning data database 12b, data of a feature amount that are a “FEATURE AMOUNT #2-1” to a “FEATURE AMOUNT #2-10” that are collected in a case where a moving velocity of the terminal device 10 is “5 km/h (kilometers per hour)-10 km/h” are registered as learning data that indicate a “moving state”.

In the learning data database 12b, 10 data of feature amount collected in each of velocity zones with moving velocities of the terminal device 10 being “10 km/h (kilometers per hour)-20 km/h”, “20 km/h-30 km/h”, “30 km/h-40 km/h”, “40 km/h-50 km/h”, “50 km/h-60 km/h”, and “60 km/h or higher” are also registered.

That is, in an example as illustrated in FIG. 3, 70 learning data that indicate a moving state and 60 learning data that indicate a stop state are registered in the learning data database 12b. Although a conceptual value such as “FEATURE AMOUNT #1-1” as learning data is described in an example as illustrated in FIG. 3, an embodiment is not limited thereto. For example, a moving velocity of a car in a case where each feature amount is collected being associated with each feature amount is registered in the learning data database 12b. As will be clear in a description provided later, an average, a standard deviation, a maximum, and a minimum of sets of a magnitude of acceleration in a reference direction and a magnitude of acceleration on a plane perpendicular to the reference direction are also registered as data that indicate a feature amount, together with a moving velocity in a case where such a feature amount is acquired, in the learning data database 12b.

Although an example of a case where feature amounts are registered in each velocity zone at an interval of 5 km/h or 10 km/h is described in an example as illustrated in FIG. 3, an embodiment is not limited thereto and the terminal device 10 can set a range of a velocity zone at any value. For example, the terminal device 10 may set a range of a velocity zone in units of 1 km/h or may set different ranges for respective velocity zones.

In the estimated velocity database 12c, a moving velocity of a car (that will be described as an “estimated velocity” below) that is estimated from detected acceleration is registered by using a learner as described later. For example, FIG. 4 is a diagram illustrating an example of information that is registered in an estimated velocity database according to an embodiment. As illustrated in FIG. 4, information that has items of “POINT OF TIME” and “ESTIMATED VELOCITY” is registered in the estimated velocity database 12c. Herein, a “POINT OF TIME” as illustrated in FIG. 4 is information that indicates a point of time when acceleration that is used for estimating an estimated velocity is measured. A “POINT OF TIME” may be information that indicates a point of time when an associated estimated velocity is estimated, or may be information that indicates an order of estimation of respective estimated velocities, where newly estimated velocity is provided as a “t”-th estimated velocity. An “estimated velocity” is information that indicates a moving velocity of a car that is estimated from detected acceleration.

For example, in an example as illustrated in FIG. 4, estimated velocities “V_{L-14}” to “V_{L-1}” at points of time “t-14” to “t-1” are registered in the estimated velocity database 12c. Points of time “t-14” to “t-1” are conceptual values that indicate a point of time or an order of calculation of an estimated velocity in a past while “t” is a current point of time, and an embodiment is not limited thereto. For example, in a case where the terminal device 10 estimates an estimated velocity every 1 second, estimated velocities that had been estimated by 15 seconds prior thereto are registered in the estimated velocity database 12c.

In the model database 12d, a plurality of learners that determine a moving state of the terminal device 10 in a case where a feature amount that is acquired from detected acceleration is input, that is, a model is registered. More specifically, a model (that will be described as a “stop determination model”, below) that determines whether or not a car stops as a feature amount acquired from detected acceleration is input, and a model (that will be described as a “velocity estimation model”, below) that has learned a moving velocity that produces an input feature amount are registered in the model database 12d.

Herein, a stop determination model and a velocity estimation model that are registered in the model database 12d will be described. A stop determination model and a velocity estimation model are learners that have executed learning of a moving state of a car by using, as answer data, a moving velocity of a car in a case where acceleration is detected by the terminal device 10, and detected acceleration or a feature amount acquired from the acceleration. For example, for a stop determination model or a velocity estimation model, it is possible to adopt any learner or model such as a linear classifier such as an SVM that classifies input data, a neural network, or a Deep Neural Network (DNN).

A stop determination model is a learner that has executed learning so as to determine whether or not a car stops in a case where a feature amount is input and then acceleration that is acquisition source for such a feature amount is detected. A velocity estimation model is a learner that has executed learning so as to determine whether a car runs at a velocity less than a predetermined velocity or a car runs at a velocity greater than a predetermined velocity in a case where a feature amount is input and then acceleration that is an acquisition source of such a feature amount is detected. That is, a velocity estimation model learns a feature that is included in acceleration or a feature amount that is produced in a case where a car runs at a predetermined velocity zone, and thereby, learns a velocity zone that produces input acceleration or feature amount. A velocity estimation model is a learner that classifies a moving velocity into a velocity zone greater than a predetermined velocity or a velocity zone less than the predetermined velocity, based on a feature that is included in the acquired feature amount, in a case where a moving velocity is estimated. As a more specific example is provided, a velocity estimation model learns a feature of vibration or the like that is produced in a case where a car runs in a predetermined velocity zone, and thereby, estimates a velocity zone that includes a moving velocity of the car, from the feature of vibration or the like that is indicated by detected acceleration.

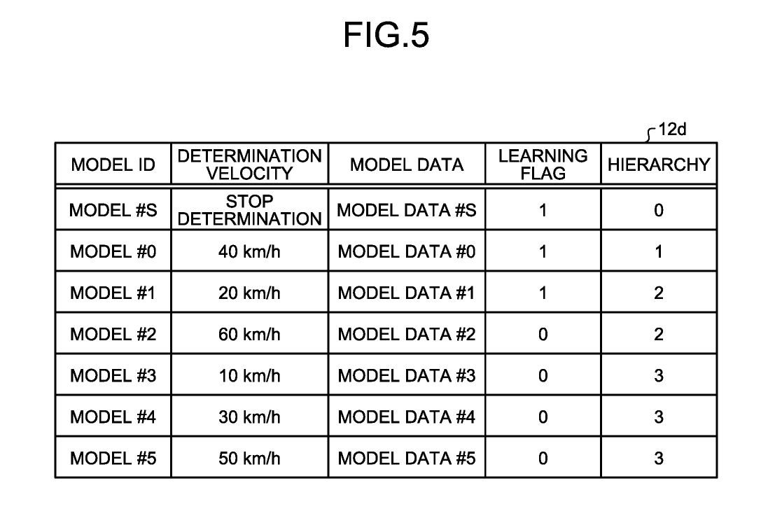

For example, FIG. 5 is a diagram illustrating an example of information that is registered in a model database according to an embodiment. As illustrated in FIG. 5, information that includes items such as a “MODEL ID (identifier)”, a “DETERMINATION VELOCITY”, “MODEL DATA”, a “LEARNING FLAG”, and a “HIERARCHY” is registered in the model database 12d. Herein, a “MODEL ID” is an identifier for a model. A “DETERMINATION VELOCITY” is a velocity that is a reference of determination for an associated model. For example, a model with a determination velocity being “40 km/h” determines whether a moving velocity is included in a velocity zone less than “40 km/h” or included in a velocity zone greater than or equal to “40 km/h”, as input of a feature amount is accepted at a time of estimation when a moving velocity is estimated. That is, a velocity estimation model registered in the model database 12d is a model that determines an input feature amount is a feature amount acquired in a case where a moving velocity is less than a predetermined determination velocity or a feature amount acquired in a case where a moving velocity is greater than or equal to such a predetermined determination velocity.

“MODEL DATA” are data of a learned stop determination model or velocity estimation model. A “LEARNING FLAG” is information that indicates whether or not learning of an associated model has been completed. For example, a learning flag of “1” is registered to be associated with a model with learning having been completed by a learning process as described later, while a learning flag of “0” is registered to be associated with a model with learning not having been completed. A “HIERARCHY” is a value that indicates priority of an associated model that is used at a time of estimation when a moving velocity is estimated, and indicates that priority of such a model is increased with decreasing the value. A “HIERARCHY” is also a value that indicates what model learning is executed from in a case where a stop determination model or a velocity estimation model is learned in a learning process as described later, as well as priority of a model that is used in a case where a moving velocity is estimated.

More specifically, an example of a case where a value of a “HIERARCHY” is set in the model database 12d in such a manner that priority of use or priority of learning of a velocity estimation model is increased that includes a determination velocity in a velocity zone with more opportunities for a car to move is described in an example as illustrated in FIG. 5. That is, in an example as illustrated in FIG. 5, a value of a “HIERARCHY” is set in the model database 12d in such a manner that priority of a velocity estimation model is increased as learning data is readily acquired in a velocity zone or a velocity zone is readily provided as a target for estimation. The terminal device 10 executes estimation of a moving velocity by using each model registered in the model database 12d in a stepwise manner, according to priority that is indicated by a “HIERARCHY”.

Although an example of a case where model data of 7 models that are indicated by model IDS of “MODEL #S” and “MODEL #0” to “MODEL #5” are stored is described in an example as illustrated in FIG. 5, an embodiment is not limited thereto and it is possible to register model data of any number of models.

Although a value of a “HIERARCHY” in an example as illustrated in FIG. 5 is set in such a manner that priority of a velocity estimation model is increased as a velocity zone is readily provided as a target for estimation, an embodiment is not limited thereto. In an estimation process as described later, a velocity zone is divided in a stepwise manner, and thereby, a velocity zone that produces an acquired feature amount is estimated. Hence, the number of stages for dividing a velocity zone is increased with increasing the number of models that can be used for an estimation process by a learning process as described later.

Herein, a value of a “HIERARCHY” that is registered in the model database 12d is practically a value that indicates a stage for dividing a velocity zone in an associated velocity estimation model. However, in a case where, among respective velocity estimation models, a model that has executed learning of a velocity zone with more opportunities to move (that is, a model with more opportunities to be used) is used or executes learning preferentially, it is sufficient to set a value of a “HIERARCHY” in such a manner that such a model is provided in an upper hierarchy (hierarchy with a smaller value).

For example, in an example as illustrated in FIG. 5, a model ID of “MODEL #S”, a determination velocity of “STOP DETERMINATION”, model data of “MODEL DATA #S”, a learning flag of “1”, and a hierarchy of “0” are associated with one another and registered in the model database 12d. Such information indicates that learning of “MODEL DATA #S” that is a stop determination model that executes “STOP DETERMINATION” as data of a model indicated by “MODEL 190 S” has been completed and the model is to be firstly used at a time of determination.

A model ID of “MODEL #0”, a determination velocity of “40 km/h”, model data of “MODEL DATA #0”, a learning flag of “1”, and a hierarchy of “1” are associated with one another and registered in the model database 12d. Such information indicates that learning of “MODEL DATA #0” that is a velocity estimation model that determines whether a moving velocity is less than “40 km/h” or greater than or equal to “40 km/h” as data of a model indicated by “MODEL #0” has been completed. Such information also indicates that “MODEL DATA #0” is a model that is used after a model with a value of hierarchy being “0” at a time of determination, that is, a model that is used after a stop determination model that is indicated by a model ID of “MODEL #S”.

A model ID of “MODEL #2”, a determination velocity of “60 km/h”, model data of “MODEL DATA #2”, a learning flag of “0”, and a hierarchy of “2” are associated with one another and registered in the model database 12d. Such information indicates that learning of “MODEL DATA #2” that is a velocity estimation model that determines whether a moving velocity is less than “60 km/h” or greater than or equal to “60 km/h” as data of a model indicated by “MODEL #2” has been completed. Such information also indicates that “MODEL DATA #2” is a model that is used after a velocity estimation model indicated by a model ID of “MODEL #0”, at a time of determination.

Thus, a plurality of learners that classifies a moving velocity of a car into mutually different velocity zone as a feature amount is input are registered in the model database 12d. In the following description, each velocity estimation model registered in the model database 12d, such as a velocity estimation model with a model ID being “MODEL #0” or velocity estimation model with a model ID being “MODEL #1”, may merely be described by a value of such a model ID.

By returning to FIG. 2, an explanation is continued. The acceleration sensor 13 measures a magnitude and a direction of acceleration according to the terminal device 10 at a predetermined time interval (for example, 5 milliseconds). For example, the acceleration sensor 13a measures acceleration in a direction of an x-axis of a terminal coordinate system. The acceleration sensor 13b measures acceleration in a direction of a y-axis of the terminal coordinate system. The acceleration sensor 13c measures acceleration in a direction of a z-axis of the terminal coordinate system. That is, the terminal device 10 provides acceleration measured by the respective acceleration sensors 13a to 13c as acceleration in directions of respective axes of the terminal coordinate system, and thereby, can acquire a vector that indicates a direction and a magnitude of acceleration with respect to the terminal device 10. Such acceleration measured by acceleration sensors 13a to 13c includes acceleration that is produced by vibration or the like that is caused in a case where a car moves, as well as gravity acceleration.

The GPS signal receiving antenna 14 is an antenna for receiving, from a satellite, a signal that is used in a satellite positioning system such as a GPS. The output unit 15 is a screen for displaying a map or a current place in a case where guiding is executed or a speaker for outputting sound.

The control unit 16 is realized in such a manner that a variety of programs such as an estimation program that is stored in a storage device inside the terminal device 10 are executed by, for example, a Central Processing Unit (CPU), a Micro Processing Unit (MPU), an Application Specific Integrated Circuit (ASIC), a Field Programmable Gate Array (FPGA), or the like, in a storage area such as an RAM provided as a work area. In an example as illustrated in FIG. 2, the control unit 16 includes a guiding execution unit 17, a sound output unit 18, an image output unit 19, and a moving state estimation unit 20 (that may collectively be described as respective processing units 17 to 20, below). The moving state estimation unit 20 includes a detection unit 21, a setting unit 22, a transformation unit 23, an acquisition unit 24, an estimation unit 25, a collection unit 26, a learning unit 27, and an updating unit 28.

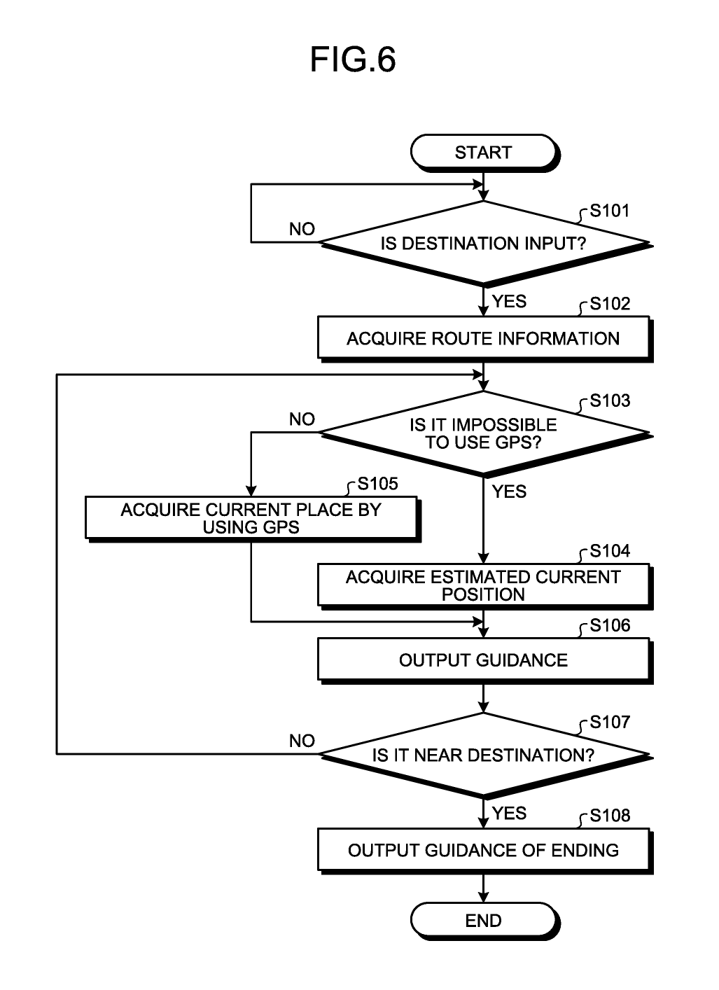

A relation of connection among the respective processing units 17 to 20 that are included in the control unit 16 is not limited to a relation of connection as illustrated in FIG. 2 but may be another relation of connection. The respective processing units 17 to 20 realize or execute a function or an action of a guiding process as described below (for example, FIG. 1, FIG. 6 to FIG. 9, and the like), where these are functional units arranged for explanation thereof and correspondence to a practical hardware component or software module is not needed. That is, the terminal device 10 may realize or execute a guiding process in any functional unit as long as a function or an action of the following guiding process can be realized or executed.

2-2. Example of Action and Effect in Guiding Process

Hereinafter, content of a guiding process that is executed or realized by the respective processing units 17 to 20 will be described by using a flowchart as illustrated in FIG. 6. FIG. 6 is a flowchart illustrating an example of a flow of a guiding process that is executed by a terminal device according to an embodiment.

First, the guiding execution unit 17 determines whether or not a destination is input from a user (step S101). In a case where a destination is input (step S101: Yes), the guiding execution unit 17 acquires route information from an external server with omitted illustration thereof (step S102). Herein, the guiding execution unit 17 determines whether or not it is possible to use a GPS (step S103).

For example, in a case where it is not possible for the GPS signal receiving antenna 14 to receive a signal from a satellite, a case where the number of satellites with a signal being able to be received therefrom is less than a predetermined threshold, or the like, the guiding execution unit 17 determines that it is not possible to use a GPS (step S103: Yes) and acquires a current position from a moving direction or a velocity of a car that is estimated by the moving state estimation unit 20 (step S104). For example, the guiding execution unit 17 acquires a current place that is estimated by the moving state estimation unit 20. Specific content of a process of estimating a current place of a car by the moving state estimation unit 20 will be described later.

On the other hand, in a case where the guiding execution unit 17 determines that it is possible to use a GPS (step S103: No), a current place is identified by the GPS (step S105). Then, the guiding execution unit 17 controls the sound output unit 18 or the image output unit 19, and outputs guidance by using a current place provided by using a GPS or an estimated current place (step S106). For example, the sound output unit 18 outputs sound that indicates a current place, a direction with a car traveling therein, or the like from the output unit 15 according to control by the guiding execution unit 17. The image output unit 19 outputs an image with a current place being superimposed on a surrounding map or an image that indicates a direction with a car traveling therein or the like from the output unit 15 according to control by the guiding execution unit 17.

Subsequently, the guiding execution unit 17 determines whether or not a current place is near a destination (step S107). In a case where it is determined that a current place is near a destination (step S107: Yes), the guiding execution unit 17 controls the sound output unit 18 or the image output unit 19 so as to output guidance of ending that indicates an end of guiding (step S108) and end the process. On the other hand, in a case where it is determined that a current place is not near a destination (step S107: No), the guiding execution unit 17 executes step S103. In a case where a destination is not input (step S101: No), the guiding execution unit 17 waits until input is provided.

2-3. Example of Action and Effect in Acquisition Process

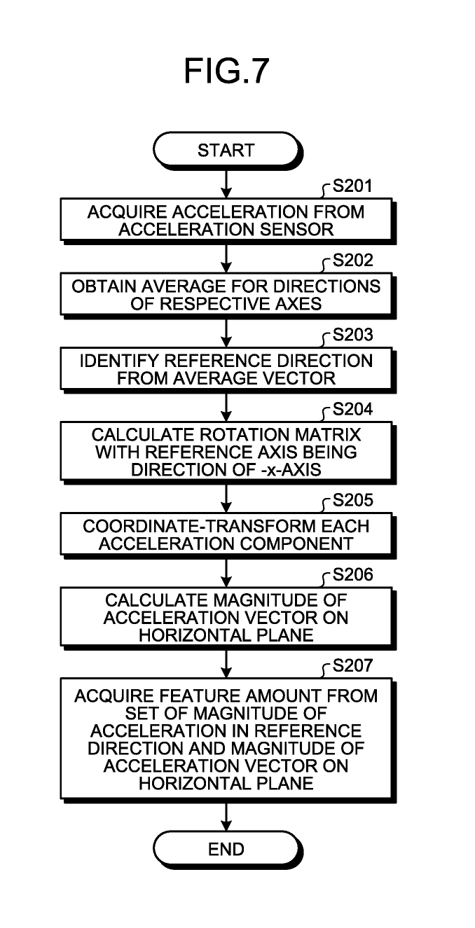

Next, content of an acquisition process that is executed or realized by the detection unit 21, the setting unit 22, the transformation unit 23, and the acquisition unit 24 will be described by using a flowchart as illustrated in FIG. 7. FIG. 7 is a flowchart illustrating an example of a flow of an acquisition process that is executed by a terminal device according to an embodiment. The detection unit 21, the setting unit 22, the transformation unit 23, and the acquisition unit 24 execute an acquisition process as illustrated in FIG. 7 at a predetermined interval (for example, 1 second). Respective steps as illustrated in FIG. 7 correspond to, for example, steps as illustrated in (A) to (D) of FIG. 1.

For example, the detection unit 21 acquires acceleration from the acceleration sensor 13 (step S201). Specifically, the acceleration sensor 13 acquires a magnitude of acceleration measured in a direction of each of (x, y, z) axes of a terminal coordinate system at a predetermined time interval. The detection unit 21 calculates an average of magnitudes of acceleration measured by the acceleration sensor 13 during a predetermined period of time in a direction of each axis of a terminal coordinate system (step S202). For example, the detection unit 21 collects, for 1 second, acceleration in a terminal coordinate system that is detected by the acceleration sensor 13 every 5 seconds. Then, the detection unit 21 calculates each of an average xₘ of respective values of collected acceleration in a direction of an x-axis, an average yₘ of values in a direction of a y-axis, and an average zₘ of values in a direction of a z-axis, and provides a vector (xₘ, yₘ, zₘ) composed of the calculated averages in directions of respective axes as an average vector G.

Subsequently, the setting unit 22 identifies a reference direction based on acceleration calculated by the detection unit 21 (step S203). More specifically, the setting unit 22 provides a direction of an average vector G composed of averages of acceleration calculated by the detection unit 21 as a reference direction. Then, the transformation unit 23 calculates a rotation matrix for causing a direction of a predetermined axis of a terminal coordinate system to correspond to a reference direction set by the setting unit 22 (step S204). Then, the transformation unit 23 transforms each component of acceleration acquired in a terminal coordinate system by the detection unit 21 by using the calculated rotation matrix (step S205). That is, as illustrated in (A) of FIG. 1, the transformation unit 23 transforms acceleration acquired by the detection unit 21 into acceleration not in a car coordinate system but in a coordinate system with a reference being provided in a reference direction.

For example, as illustrated in (B) of FIG. 1, the setting unit 22 sets a reference direction at a direction of an average vector G of acceleration. Then, as illustrated in (C) of FIG. 1, the transformation unit 23 calculates a rotation matrix with a direction of a −x-axis of a terminal coordinate system corresponding to a direction of an average vector G. The transformation unit 23 may adopt any rotation matrix as long as the rotation matrix is such that a direction of a −x-axis of a terminal coordinate system corresponds to a direction of an average vector G. That is, the transformation unit 23 may adopt a rotation matrix for rotating a direction of a y-axis or a direction of a z-axis to any direction.

Then, the transformation unit 23 transforms acceleration measured in a terminal coordinate system into that in a coordinate system with a reference being an average of acceleration (that will be described as an “estimation coordinate system”, below) by using the calculated rotation matrix. In the following description, a direction of an average vector G in an estimation coordinate system is provided as a direction of a −x-axis. In the following description, a direction of a −x-axis in an estimation coordinate system may be described as a reference direction.

Subsequently, the acquisition unit 24 calculates a magnitude of an acceleration vector on a plane perpendicular to a direction of an average vector (that will be described as a horizontal plane, below), that is, a yz-plane in an estimation coordinate system (step S206). Then, the acquisition unit 24 acquires a feature amount from a set of a magnitude of an average vector and a magnitude of an acceleration vector on a horizontal plane (step S207).

For example, as illustrated in (D) of FIG. 1, the acquisition unit 24 obtains a set of a magnitude “a_hor” of acceleration on a horizontal plane and a magnitude of acceleration of an average vector G, that is, a magnitude “a_ver” of acceleration in a reference direction of an estimation coordinate system, among respective axis components of acceleration coordinate-transformed by the transformation unit 23. More specifically, as components of acceleration in an estimation coordinate system are described as “a_x, a_y, a_z”, the acquisition unit 24 calculates a value of a square root of a sum of a square of a component of “a_y” and a square of a component of “a_z” as “a_hor”.

Then, the acquisition unit 24 acquires, as feature amounts, an average, a maximum, a minimum, and a standard deviation for a predetermined period of time, with respect to a set of calculated “a_hor” and “a_ver”, that is, “(a_ver, a_hor)” that is a set of a magnitude of acceleration on a horizontal plane and a magnitude of acceleration in a reference direction. The acquisition unit 24 may provide at least one of an average, a maximum, a minimum, and a standard deviation for a predetermined period of time with respect to “(a_ver, a_hor)” as a feature amount. Thus, the acquisition unit 24 acquires a feature amount based on acceleration in a direction with a reference being a reference direction. Then, the estimation unit 25 determines a moving state of the terminal device 10 by using a feature amount acquired by the acquisition unit 24.

Thus, the terminal device 10 does not calculate a direction of force of gravity or a moving direction of a car but provides a direction of an average vector as a reference direction for executing stop determination or an estimation process for estimating a moving velocity. Herein, in a case where a car stops or a case where a car moves at a uniform velocity, an average vector is expected to indicate a direction of gravity acceleration. Hence, in a case where a car stops or a case where a car moves at a uniform velocity, a reference direction corresponds to a direction of gravity acceleration. On the other hand, in a case where a car executes acceleration or deceleration, a direction of an average vector G is expected to deviate from a direction of gravity acceleration.

However, as will be clear in a description as provided later, the terminal device 10 learns a stop determination model for determining whether or not a car stops and a velocity estimation model for estimating a velocity zone with a car moving therein, by using a feature amount based on acceleration. Such a model that has executed learning can estimate a moving state of a car from a feature amount that is included in acceleration that is produced by generation of vibration or a feature amount that is included in acceleration that is produced by movement of a car, independently of a direction of force of gravity or a moving direction of a car. As a result, even in a case where an error exits in a direction of an average vector G or a direction of gravity acceleration, the terminal device 10 is capable of absorbing such an error.

2-4. Example of Action and Effect in Estimation Process

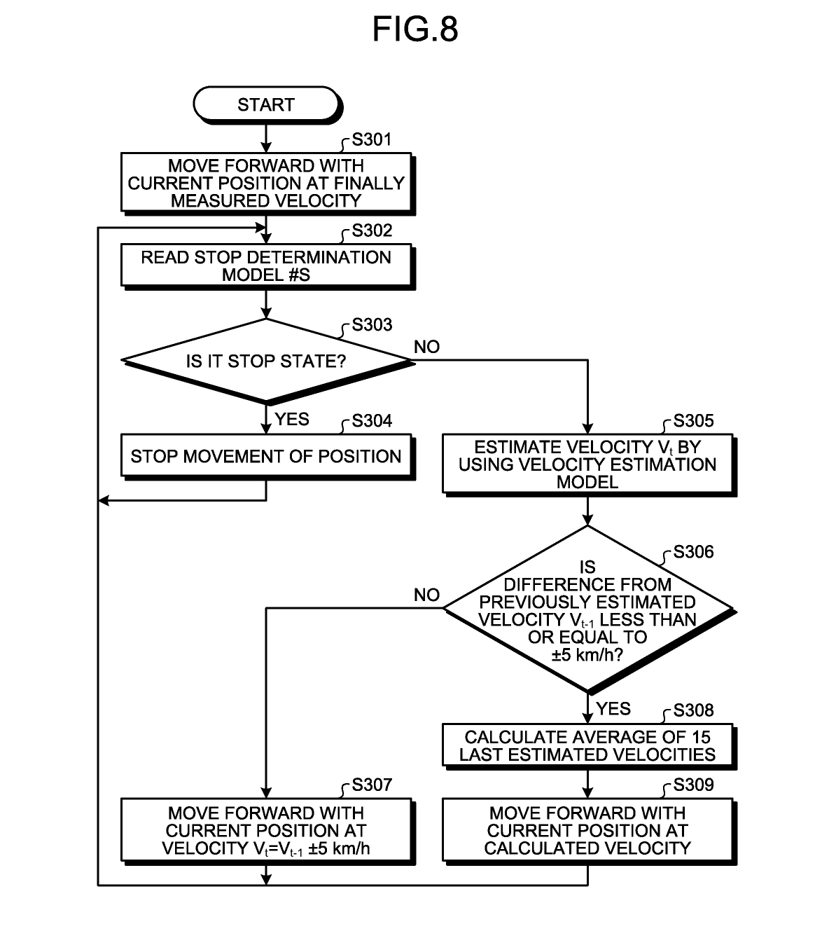

Next, content of an estimation process that is executed or realized by the estimation unit 25 will be described by using a flowchart as illustrated in FIG. 8. FIG. 8 is a flowchart illustrating an example of a flow of an estimation process that is executed by a terminal device according to an embodiment. For example, in a case where it is determined that it is not possible to use a GPS at step S103 in FIG. 6, the estimation unit 25 executes an estimation process as illustrated in FIG. 8. A result of an estimation process as illustrated in FIG. 8 is output to the guiding execution unit 17 as a current place estimated by the moving state estimation unit 20.

First, the estimation unit 25 estimates a current place, in such a manner that a car is assumed to travel in a traveling direction measured at a time when it becomes impossible to use a GPS, from a position where it becomes impossible to use the GPS, at a finally measured velocity, that is, a velocity measured at a time when it becomes impossible to use the GPS (step S301). For example, the estimation unit 25 estimates a current place in such a manner that, in a case where a car enters a tunnel, the car is assumed to continue to travel at a velocity and in a direction at a time when the car enters the tunnel. The estimation unit 25 may acquire information of a route with a car moving thereon from the guiding information database 12a, and estimate that the car moves along the acquired route.

Subsequently, the estimation unit 25 reads a stop determination model from the model database 12d (step S302). That is, the estimation unit 25 reads a model with a value of a hierarchy being “0” (model with highest priority), that is, MODEL #S that is a stop determination model, among models registered in the model database 12d. Then, the estimation unit 25 determines whether or not a car is provided in a stop state by using the read stop determination model (step S303).

Specifically, the estimation unit 25 inputs a feature amount acquired by the acquisition unit 24 in an acquisition process to the read model and determines whether or not a car is provided in a stop state. That is, the estimation unit 25 determines a moving state of the terminal device 10 by using a stop determination model that has learned a feature that is included in a feature amount acquired in a case where a car stops or a feature amount acquired in a case where a car does not stop. Thus, the estimation unit 25 determines a moving state of the terminal device 10 by using a feature amount acquired by the acquisition unit 24.

Then, in a case where it is determined that a car is provided in a stop state (step S303: Yes), the estimation unit 25 stops movement of a current place to be estimated (step S304), and subsequently, executes step S302. On the other hand, in a case where it is determined that a car is not provided in a stop state (step S303: No), the estimation unit 25 estimates a moving velocity Vₜ of the car at a point of time “t” by using a plurality of velocity estimation models registered in the model database 12d (step S305). That is, the estimation unit 25 estimates a moving velocity of a car from the detected acceleration by using a learner that has learned a feature amount of acceleration that is produced in each velocity zone.

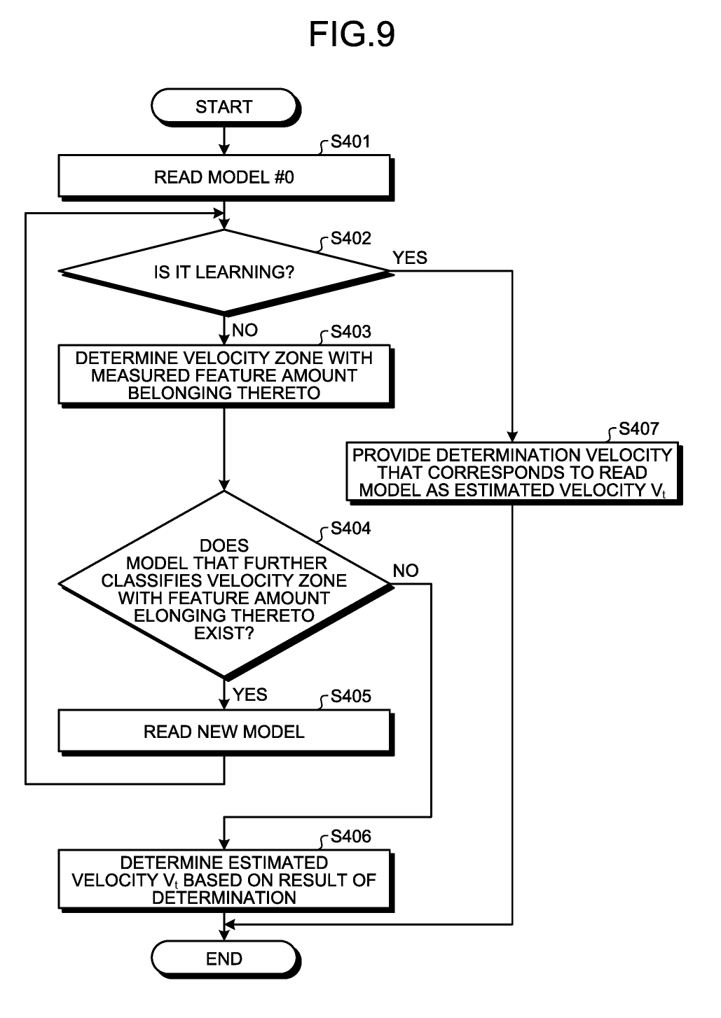

For example, FIG. 9 is a flowchart illustrating an example of a flow of a process of estimating a moving velocity in a terminal device according to an embodiment. As illustrated in FIG. 9, the estimation unit 25 estimates a moving velocity of a car from the detected acceleration by using a model registered in the model database 12d in a stepwise manner. A process as illustrated in FIG. 9 corresponds to a process as illustrated at step S305 illustrated in FIG. 8. Hereinafter, an example of a process of estimating a moving velocity “Vₜ” at a point of time “t” from a feature amount acquired at the point of time “t” will be described.

First, the estimation unit 25 reads a model with a value of a “HIERARCHY” being smallest, that is, MODEL #0 that is a velocity estimation model with highest priority, among velocity estimation models registered in the model database 12d (step S401). Subsequently, the estimation unit 25 determines whether or not MODEL #0 is learning, with reference to a value of a learning flag associated with read MODEL #0 (step S402).

Then, in a case where MODEL #0 is not learning (step S402: No), that is, a case where a value of a learning flag associated with MODEL #0 is “1”, the estimation unit 25 identifies a velocity zone with a feature amount acquired by the acquisition unit 24 belonging thereto, by using MODEL #0 (step S403). That is, the estimation unit 25 executes estimation of a moving velocity by firstly using a velocity estimation model with an average moving velocity of a car being provided as a determination velocity.

Subsequently, in a case where a velocity zone with a feature amount belonging thereto is estimated, the estimation unit 25 determines whether or not a velocity estimation model that further classifies an estimated velocity zone is registered in the model database 12d (step S404). For example, in a case where it is determined that an input feature amount is a feature amount acquired in a case where a moving velocity is greater than or equal to a velocity of “40 km/h” according to MODEL #0, the estimation unit 25 identifies a velocity estimation model with a value of a hierarchy being smallest (for example, MODEL #2), among velocity estimation models that are included in a velocity zone with a determination velocity being greater than or equal to a velocity of “40 km/h”.

Then, in a case where a velocity estimation model that further classifies a velocity zone with an input feature amount belonging thereto is registered in the model database 12d (step S404: Yes), the estimation unit 25 reads a new velocity estimation model from the model database 12d (step S405) and executes step S402. On the other hand, in a case where a velocity estimation model that further classifies a velocity zone with an input feature amount belonging thereto is not registered in the model database 12d (step S404: No), the estimation unit 25 determines an estimated velocity Vₜ that is an estimated moving velocity based on a result of determination (step S406) and ends the process. On the other hand, in a case where a read velocity estimation model is learning (step S402: Yes), that is, a case where a value of a learning flag of a read velocity estimation model is “0”, the estimation unit 25 provides a determination velocity associated with the read velocity estimation model as an estimated velocity Vₜ (step S407) and ends the process.

Herein, an example of a process that is executed by the estimation unit 25 will be described by using a view indicated by (E) of FIG. 1. For example, as illustrated in (E) of FIG. 1, the estimation unit 25 executes estimation of a moving velocity by using a plurality of velocity estimation models that classifies data of a feature amount into mutually different velocity zones, in order, from a velocity estimation model that executes classification into a predetermined velocity zone. As a more specific example is described, the estimation unit 25 inputs data of a feature amount to MODEL #S that is a stop determination model (step S1). Then, in a case where it is determined that an input feature amount is a feature amount with a stop according to MODEL #S (step S2), the estimation unit 25 determines that a moving velocity of a car is a velocity of “0 km/h” (step S3). That is, the estimation unit 25 determines that a car is provided in a stop state.

On the other hand, in a case where it is determined that an input feature amount is a feature amount with no stop according to MODEL #S (step S4), the estimation unit 25 inputs a feature amount to MODEL #0 that is a model with highest priority among velocity estimation models. Then, in a case where it is determined that a moving velocity is greater than or equal to a velocity of “40 km/h” according to MODEL #0 (step S5), the estimation unit 25 inputs a feature amount to MODEL #2 with a determination velocity being a velocity of “60 km/h”.

Thus, the estimation unit 25 estimates a velocity zone that includes a moving velocity in a case where a feature amount is acquired by using MODEL #2 that classifies a velocity zone greater than or equal to a velocity of “40 km/h” that is provided by classifying a feature amount according to MODEL #0 into a velocity zone less than a velocity of “60 km/h” and a velocity zone greater than or equal to a velocity of “60 km/h”. That is, in a case where a velocity estimation model that determines whether or not a moving velocity is in a first velocity zone determines that a moving velocity of a car is included in a first velocity zone, from a detected acceleration, the estimation unit 25 estimates a moving velocity of a car from the detected acceleration, by using a velocity estimation model that determines whether or not a velocity zone is a second velocity zone that is included in the first velocity zone.

In a case where it is determined that a moving velocity is greater than or equal to a velocity of “60 km/h” according to MODEL #2 (step S6), the estimation unit 25 determines that it exceeds a velocity zone capable of estimation and provides a moving velocity at a time of entry into a tunnel as an estimated velocity Vₜ. That is, in a case where it is estimated that a velocity zone that produces detected acceleration is a velocity zone greater than a predetermined upper limit velocity, the estimation unit 25 provides a velocity that is finally measured by a predetermined measurement means such as a GPS as an estimated velocity. On the other hand, in a case where it is determined that a moving velocity is less than a velocity of “60 km/h” according to MODEL #2 (step S7), the estimation unit 25 inputs a feature amount to MODEL #5 with a determination velocity being a velocity of “50 km/h”.

In a case where it is determined that a moving velocity is less than a velocity of “50 km/h” according to MODEL #5, the estimation unit 25 can estimate that a moving velocity is greater than or equal to a velocity of “40 km/h” and less than a velocity of “50 km/h” based on determination that uses MODEL #0, MODEL #2, and MODEL #5. For example, in a case where it is determined that a moving velocity is less than a velocity of “50 km/h” according to MODEL #5, the estimation unit 25 provides a velocity of “45 km/h” as an estimated velocity Vₜ (step S8).

Similarly, for example, in a case where it is determined that a moving velocity is greater than or equal to a velocity of “50 km/h” according to MODEL #5, the estimation unit 25 can estimate that a moving velocity is greater than or equal to a velocity of “50 km/h” and less than “60 km/h”. In a case where it is determined that a moving velocity is greater than or equal to a velocity of “50 km/h” according to MODEL #5, the estimation unit 25 provides a velocity of “55 km/h” as an estimated velocity Vₜ (step S9).

In a case where learning of MODEL #5 has not been completed (step S10), the estimation unit 25 outputs a velocity of “50 km/h” that is a determination velocity of MODEL #5 as an estimated velocity. In a case where MODEL #0 is learning, the estimation unit 25 does not output a determination velocity of “40 km/h” of MODEL #0 but outputs, for example, a finally measured velocity (velocity at a time of entry into a tunnel) as an estimated velocity Vₜ.

In a case where it is determined that a moving velocity is less than a velocity of “40 km/h” according to MODEL #0, the estimation unit 25 estimates an estimated velocity Vₜ by using MODEL #1, MODEL #3, and MODEL #4 in a stepwise manner. Thus, the estimation unit 25 limits a velocity zone with a moving velocity belonging thereto in a step wise manner by using respective velocity estimation models in a stepwise manner, to estimate an estimated velocity Vₜ. The estimation unit 25 estimates a moving velocity by using respective velocity estimation models, in order, from a model with a general moving velocity being provided as a determination velocity, such as MODEL #0, and hence, can realize, for example, estimation of a moving velocity at a time of entry into a tunnel.

Subsequently, as illustrated in (F) of FIG. 1, the estimation unit 25 corrects a result of estimation with a high possibility of erroneous estimation based on an amount of a change of an estimated velocity and outputs a corrected estimated velocity Vₜ. A more specific explanation will be provided by using FIG. 8. For example, in a case where an estimated velocity Vₜ is estimated, the estimation unit 25 determines whether or not a difference between a previously estimated velocity Vₜ₋₁ and an estimated velocity Vₜ is less than or equal to “±5 km/h”, with reference to the estimated velocity database 12c (step S306). Then, in a case where a difference between an estimated velocity Vₜ₋₁ and an estimated velocity Vₜ is greater than “±5 km/h” (step S306: No), the estimation unit 25 moves forward with a current position while a value provided by adding a value of “±5 km/h” to an estimated velocity Vₜ₋₁ to provide an estimated velocity Vₜ (step S307) and executes step S302.

For example, the estimation unit 25 provides a value provided by adding “5 km/h” to an estimated velocity Vₜ₋₁ as an estimated velocity Vₜ in a case where a value provided by subtracting an estimated velocity Vₜ₋₁ from an estimated velocity Vₜ is greater than “±5 km/h”, or provides a value provided by subtracting “5 km/h” from an estimated velocity Vₜ₋₁ as estimated velocity Vₜ in a case where a value provided by subtracting an estimated velocity Vₜ₋₁ from an estimated velocity Vₜ is less than “−5 km/h”. Thus, in a case where it is estimated that actually impossible extreme acceleration or deceleration that is executed, the estimation unit 25 provides, as a newly estimated velocity, a value provided by adding to or subtracting from a previously estimated velocity Vt-1, a predetermined value. As a result, the estimation unit 25 can prevent erroneous estimation. As long as an actually impossible change of an estimated velocity is prevented, the estimation unit 25 may execute any process other than the process as described above.

On the other hand, in a case where a difference between a previously estimated velocity Vₜ₋₁ and an estimated velocity Vₜ is less than or equal to “±5 km/h” (step S306: Yes), the estimation unit 25 calculates an average of 15 last estimated velocities (step S308). More specifically, the estimation unit 25 provides, as an estimated velocity Vₜ, a value provided by dividing a sum of values of estimated velocities Vₜ to Vₜ₋₁₄ that are estimated for last 15 seconds by “15”. Then, the estimation unit 25 moves forward with a current position at the calculated estimated velocity Vₜ (step S309), executes a process of updating the estimated velocity database 12c, and executes step S302.

For example, the estimation unit 25 deletes the estimated velocity Vₜ₋₁₄ registered in the estimated velocity database 12c to change the estimated velocities Vₜ₋₁₃ to Vₜ₋₁ at point of time t-13 to t-1 to the estimated velocities Vₜ₋₁₄ to Vₜ₋₂ at points of time t-14 to t-2, as a process of updating the estimated velocity database 12c. Then, the estimation unit 25 registers a newly calculated estimated velocity Vₜ as Vₜ₋₁ in the estimated velocity database 12c. The estimation unit 25 may use an average of moving velocities that are estimated for 30 seconds and may execute correction of estimated velocities depending on an amount of a change of a moving velocity estimated in a past.

2-5. Example of Action and Effect in Learning Process

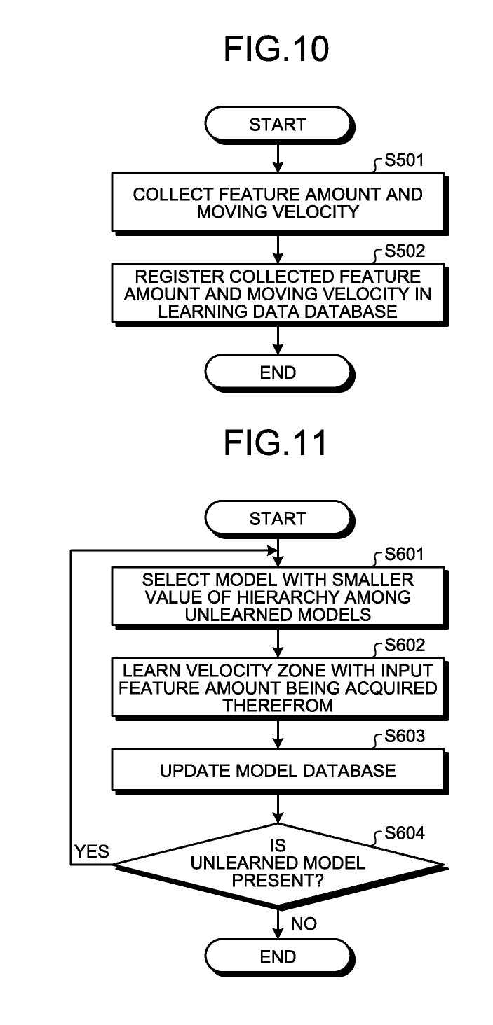

Next, content of a learning process that is executed or realized by the collection unit 26, the learning unit 27, and the updating unit 28 will be described by using flowcharts as illustrated in FIG. 10 and FIG. 11. First, an example of a process of the collection unit 26 to collect learning data that are used in a learning process will be described by using FIG. 10. FIG. 10 is a flowchart illustrating an example of a flow of a process of a terminal device according to an embodiment to collect learning data. The collection unit 26 repeatedly executes a process as illustrated in FIG. 10 at a predetermined time interval.

For example, in a case where a moving velocity can be measured, the collection unit 26 collects a feature amount acquired by the acquisition unit 24 and a measured moving velocity (step S501). More specifically, the collection unit 26 measures a moving velocity of a car by using a GPS. The collection unit 26 may acquire a moving velocity of a car through a general standard for acquiring information from an information system or a control device of a control system that is included in a car, such as an On-Board diagnostics (OBD) terminal. The collection unit 26 may acquire a moving velocity of a car from an information system or a control device of a control system that is included in a car, by using a near field communication technique such as Bluetooth (registered trademark). Thus, in a case where a moving velocity is directly acquired from a control device that is included in a car, accuracy of learning of a velocity estimation model can be improved more than estimation of a moving velocity that uses a GPS.

Then, the collection unit 26 registers a set of a collected feature amount and moving velocity as learning data in the learning data database 12b (step S502) and ends the process. More specifically, the collection unit 26 associates, and registers in the learning data database 12b, learning data with a velocity zone that includes a moving velocity that is included in learning data. In a case where the number of learning data associated with a velocity zone that includes an identified moving velocity reaches an upper limit (for example, “10” in a case of a moving state, “60” in a case of a stop state, or the like), the collection unit 26 updates oldest learning data to a newly acquired feature amount, among associated learning data.

For example, it is considered that a deviation of a moving velocity of a car is caused depending on a running mode of the car. For example, it is expected that a distribution of a moving velocity of a car with many opportunities to move in a city is a distribution centered at a moving velocity less than a moving velocity of a car with many opportunities to move on an expressway. Hence, in a case where a set of a moving velocity that is measured by the terminal device 10 and a feature amount is provided as learning data, a deviation of a collected feature amount is caused, and hence, accuracy of determination of a model may be degraded.

For example, in a case where learning of a model is executed based on learning data that are mostly composed of a feature amount collected at a time when the terminal device 10 moves at a velocity greater than or equal to a velocity of “80 km/h”, accuracy of determination in a case of moving in another velocity zone may be degraded. Hence, the collection unit 26 collects, for each velocity zone, a predetermined number of feature amounts as learning data in order from a newly acquired feature amount. As a result, the collection unit 26 prevents a deviation of a velocity in learning data for a moving state, so that accuracy of determination based on a model with learning having been executed by using learning data registered in the learning data database 12b can be improved.

Next, an example of a process of the learning unit 27 and the updating unit 28 to cause a model to learn by using learning data collected by the collection unit 26 will be described by using FIG. 11. FIG. 11 is a flowchart illustrating an example of a flow of a process of a terminal device according to an embodiment to cause a model to learn.

As illustrated in FIG. 11, the learning unit 27 executes learning of a model to learn a velocity zone with a feature amount being detected therein, by using learning data registered in the learning data database 12b. More specifically, the learning unit 27 executes learning of each model in an order dependent on a velocity zone that is learned by a mode, for example, in order from a model that learns a velocity zone with a car having more opportunities to move therein. That is, the learning unit 27 executes learning of each model in an order similar to an order with each model dividing a velocity zone in a stepwise manner in an estimation process (in an order similar to an order that is used to estimate a velocity).

For example, the learning unit 27 selects, with reference to the model database 12d, a model with a value of a hierarchy being less than that of another model and a smallest determination velocity, among unlearned models with a learning model being “0” (step S601). That is, the learning unit 27 executes learning of a model in order of decreasing a possibility of being used in an estimation process. Subsequently, the learning unit 27 causes a model that has selected a velocity zone with an input feature amount being acquired therefrom to learn by using learning data registered in the learning data database 12b (step S602).

More specifically, the learning unit 27 executes learning of a model in such a manner that an input feature amount is classified into a feature amount that is acquired in a case where a car moves at a velocity less than a determination velocity and a feature amount that is acquired in a case where a car moves at a velocity greater than or equal to the determination velocity. That is, the learning unit 27 generates a classifier that executes classification for a velocity zone that produces a feature amount, wherein the classifier executes classification of a velocity zone that produces an input feature amount into a velocity greater than or equal to a determination velocity and a velocity less than the determination velocity.

As a specific example is provided, as illustrated in (E) of FIG. 1, the learning unit 27 executes learning of MODEL #0 by using learning data at a time of movement, executes learning of MODEL #1 by using a feature amount acquired at a velocity less than “40 km/h”, and executes learning of MODEL #2 by using a feature amount acquired at a velocity greater than or equal to “40 km/h”. Subsequently, the learning unit 27 executes learning of MODEL #3 by using a feature amount acquired at a velocity less than “20 km/h”, executes learning of MODEL #4 by using a feature amount acquired at a velocity greater than or equal to “20 km/h”, and executes learning of MODEL #5 by using a feature amount acquired at a velocity less than “60 km/h”. That is, the learning unit 27 executes learning of a velocity estimation model by using learning data of a velocity zone with classification of such a velocity estimation model provided as a learning target being executed therein. Then, the updating unit 28 registers a model with learning having been executed, in the model database 12d, and updates a learning flag of the registered model to “1” (step S603).

In a state where a car stops, there is no vibration from a road surface, so that it is considered that a value of “a_ver” or a reference direction substantially corresponds to gravity acceleration and a value of “a_hor” is substantially zero. On the other hand, in a case where a car runs at a constant velocity, values of a maximum, a minimum, and a standard deviation of values of “a_ver” or “a_hor” have a feature corresponding to a moving velocity of a car based on random vibration from a road surface. In a state where a car is accelerated or decelerated, acceleration involved with acceleration or deceleration of a car as well as gravity acceleration is added, and hence, it is estimated that a magnitude of “a_ver” is greater than gravity acceleration and “a_hor” is different from that in a case where a car stops.

Hence, the learning unit 27 can cause a model that accurately determines whether or not a car stops or a velocity zone that includes a moving velocity of a car to learn, based on an average, a minimum, a maximum, and a standard deviation of “(a_ver, a_hor)”. In a case where learning data registered in the learning data database 12b are utilized as training data, the learning unit 27 can also generate a model that executes classification or determination in any mode, other than a stop determination model or a velocity determination model as described above, by any model learning means.

Subsequently, the learning unit 27 determines whether or not there is still an unlearned model, again with reference to the model database 12d (step S604). Then, in a case where there is not an unlearned model (step S604: No), the updating unit 28 ends the process directly. On the other hand, in a case where an unlearned model exists (step S604: Yes), the updating unit 28 executes step S601.

Herein, a value of “HIERARCHY” that indicates priority dependent on a velocity zone that is learned by each model is set in the model database 12d. Then, the estimation unit 25 executes estimation of a moving velocity by using a learned model in order of decreasing priority. That is, the terminal device 10 gradually narrows a velocity zone with an estimated moving velocity belonging thereto, by using a model registered in the model database 12d in a stepwise manner in an order dependent on a velocity zone that is learned by each model.

Hence, for example, in a case where it is determined that a moving velocity is greater than or equal to a velocity of “40 km/h” by using MODEL #0, the terminal device 10 can determine that at least a moving velocity is greater than or equal to a velocity of “40 km/h” even in a case where MODEL #2 is not a learned one. Similarly, in a case where it is determined that a moving velocity is a velocity greater than or equal to “20 km/h” by using MODEL #1, the terminal device 10 can determine that at least a moving velocity is velocity greater than or equal to “20 km/h” and less than “40 km/h” even in a case where MODEL #4 is not a learned one.

Hence, the learning unit 27 executes learning of a model in a decreasing order of priority according to a value of a “HIERARCHY”. That is, the learning unit 27 causes, a model that is used in a stepwise manner in an estimation process, to learn in an order identical to an order that is used in the estimation process. Hence, the terminal device 10 starts an estimation process that uses each model, even in a case where a car enters a tunnel, before learning of all models that are used in an estimation process has been completed.

3. Example of Mathematical Formula

Next, an example of a process of the transformation unit 23 to calculate a rotation matrix that transforms a terminal coordinate system into an estimation coordinate system by a mathematical formula will be described. A process that is executed by the transformation unit 23 is not limited to a process as indicated by the following formulas. For example, the transformation unit 23 may execute coordinate transformation from a terminal coordinate system to an estimation coordinate system by using a mathematical formula that represents linear transformation.

For example, respective axes of a terminal coordinate system are x-, y-, and z-axes, and respective axes of an estimation coordinate system are X-, Y-, and Z-axes. In such a case, a process of transforming an estimation coordinate system into a terminal coordinate system is represented by the following formula (1). In formula (1), α is a rotation angle around an x-axis, β is a rotation angle around a y-axis, γ is a rotation angle around a z-axis, Rₓ(α) is a rotation matrix that executes coordinate transformation caused by rotation around the x-axis, R_{y}(β) is a rotation matrix that executes coordinate transformation caused by rotation around the y-axis, and R_{z}(γ) is a rotation matrix that executes coordinate transformation caused by rotation around the z-axis.

$$( \begin{matrix}x \\ y \\ z\end{matrix} ) = {R}_{z} ( γ ) {R}_{y} ( β ) {R}_{x} ( α ) ( \begin{matrix}X \\ Y \\ Z\end{matrix} ) \qquad ( 1 )$$

The rotation matrix Rₓ(α), the rotation matrix R_{y}(β), and the rotation matrix R_{z}(γ) (that may collectively be described as “respective rotation matrices” below) can be represented by the following formulas (2) to (4). In an estimation coordinate system, it is sufficient for a direction of an −x-axis to be identical to a direction of an average vector G, and hence, any value is settable for a value of α.

$$\begin{matrix}{R}_{x} ( α ) = ( \begin{matrix}1 & 0 & 0 \\ 0 & cos α & - sin α \\ 0 & sin α & cos α\end{matrix} ) & ( 2 ) \\ {R}_{y} ( β ) = ( \begin{matrix}cos β & 0 & sin β \\ 0 & 1 & 0 \\ - sin β & 0 & cos β\end{matrix} ) & ( 3 ) \\ {R}_{z} ( γ ) = ( \begin{matrix}cos γ & - sin γ & 0 \\ sin γ & cos γ & 0 \\ 0 & 0 & 1\end{matrix} ) & ( 4 )\end{matrix}$$

Herein, a directio of an average vecor G is acceleration in a direction of an −X-axis, and hence, an estimation coordinate system can be represented by the following formula (5).

$$( \begin{matrix}X \\ Y \\ Z\end{matrix} ) = ( \begin{matrix}- G \\ 0 \\ 0\end{matrix} ) \qquad ( 5 )$$

On the other hand, an avegrage vector G in directions of respective axes that is detected in a terminal coordinate system is described as (aₓ, a_{y}, a_{z}). In such a case, aₓ, a_{y}, and a_{z} are values provided by transforming the average vector G as indicated by formula (5), by the respective rotation matirces, and hence, the following (6) is satisfied.

$$( \begin{matrix}{a}_{x} \\ {a}_{y} \\ {a}_{z}\end{matrix} ) = {R}_{z} ( γ ) {R}_{y} ( β ) {R}_{x} ( α ) ( \begin{matrix}- G \\ 0 \\ 0\end{matrix} ) = ( \begin{matrix}- G cos β cos γ \\ - G cos β sin γ \\ G sin β\end{matrix} ) \qquad ( 6 )$$

As a result, formula (7) is obtained from a value in a direction of a z-axis in formula (6).

$$sin β = \frac{{a}_{z}}{G} \qquad ( 7 )$$

As a magnitude of the average vector G is taken into condsideration, formula (8) is satisfied, and hence, formula (9) is obtained from values in directions of an x-axis and a y-axis in formula (6). As a result, the terminal device 10 can identify a rotation angle β around a y-axis from formulas (7) and (9).

$$\begin{matrix}{G}^{2} = {a}_{x}^{2} + {a}_{y}^{2} + {a}_{z}^{2} & ( 8 ) \\ cos β = \pm {\sqrt{1 - ( \frac{{a}_{z}}{G} )}}^{2} = \pm \frac{\sqrt{{a}_{x}^{2} + {a}_{y}^{2}}}{G} & ( 9 )\end{matrix}$$

Herein, a positive value among values as indicated in formula (9) is selected as a solution. Then, formula (10) and formula (11) are obtained from values in directions of an x-axis and a y-axis in formula (6). As a result, the terminal device 10 can identify a rotation angle y around a z-axis from formulas (10) and (11).

$$\begin{matrix}sin γ = - \frac{{a}_{y}}{\sqrt{{a}_{x}^{2} + {a}_{y}^{2}}} & ( 10 ) \\ cos γ = - \frac{{a}_{x}}{\sqrt{{a}_{x}^{2} + {a}_{y}^{2}}} & ( 11 )\end{matrix}$$

On the other hand, a process of transfoimraing a terminal coordinate system into an estimation coordinate system is inverse transformation of cooridnate transformaiton as illsutrated in formula (1), and hence, is represented by the following formula (12).

$$( \begin{matrix}X \\ Y \\ Z\end{matrix} ) = {R}_{x} ( - α ) {R}_{y} ( - β ) {R}_{z} ( - γ ) ( \begin{matrix}x \\ y \\ z\end{matrix} ) \qquad ( 12 )$$

Values of β and γ can be calculated from formulas (7), (9), (10), and (11), and hence, as only y-axis and z-axis components among samples aₓ, a_{y}, and a_{z} of acceleration in a terminal coordinate system are rotated to be transformed into an estimation coordinate system, formula (13) is provided. That is, the terminal device 10 transforms a terminal coordinate system into an estimation coordinate system by using the rotation matrix R_{y}(β) and the rotation matrix R_{z}(γ).

$$( \begin{matrix}X \\ y \\ z\end{matrix} ) = {R}_{y} ( - β ) {R}_{z} ( - γ ) ( \begin{matrix}{a}_{x} \\ {a}_{y} \\ {a}_{z}\end{matrix} ) \qquad ( 13 )$$

4. Varitations

The terminal device 10 according to the embodiment as described above is implemented in a variety of different modes other than the embodiment as described above. Hereinafter, other embodiments of the terminal device 10 described above will be described.

4-1. Variation of Hierarchy of Model

In the process as describe above, the terminal device 10 executes an estimation process or a learning process in order of ether of MODEL #S, MODEL #0, MODEL #1 or MODEL #2, MODEL #3 to #5 as illustrated in FIG. 1. However, an embodiment is not limited thereto. For example, the terminal device 10 may input a feature amount to all of MODELS #S and #0 to #5 that have no priority and estimate an estimated velocity of a car depending on a result of classification of a feature amount according to each of MODELS #S and #0 to #5. For example, in a case where MODEL #3 is determined to be a velocity greater than or equal to “10 km/h” and other models are determined to be less than a determination velocity, the terminal device 10 may provide a velocity of “15 km/h” as an estimated velocity.

In the process as described above, the terminal device 10 estimates an estimated velocity from a velocity of “5 km/h” to a velocity of “60 km/h” at an interval of “5 km/h” by using MODEL #0 to MODEL #5 as illustrated in FIG. 1. In a case where an estimated velocity is greater than or equal to a velocity of “60 km/h”, the terminal device 10 provides a tunnel entry velocity as estimated velocity. However, an embodiment is not limited thereto.

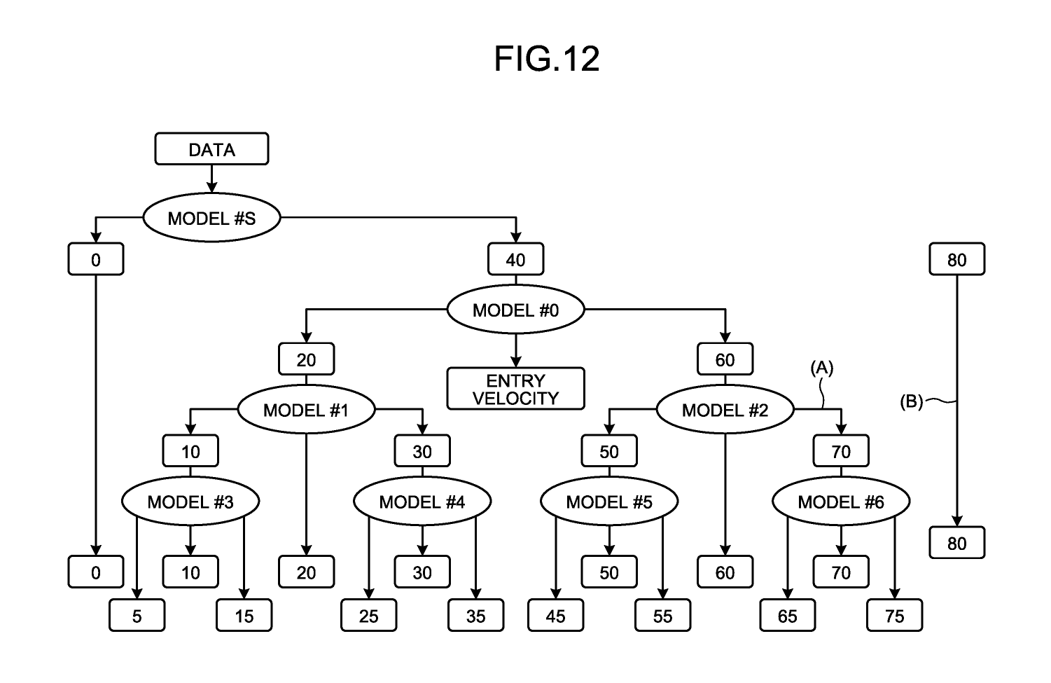

For example, FIG. 12 is a first diagram illustrating a variation of a model that uses a terminal device according to an embodiment. In an example as illustrated in FIG. 12, the terminal device 10 has MODEL #6 with a determination velocity being a velocity of “70 km/h in addition to MODEL #0 to MODEL #5. As illustrated by (A) in FIG. 12, in a case where it is determined that an acquired feature amount is a feature amount that is acquired at a time of movement at a velocity greater than or equal to “60 km/h” according to MODEL #2, the terminal device 10 inputs an acquired feature amount to MODEL #6. The terminal device 10 determines whether or not an acquired feature amount is a feature amount that is acquired at a time of movement at a velocity greater than or equal to “70 km/h”.

Herein, in a case where it is determined that an acquired feature amount is a feature amount that is acquired at a time of movement at a velocity greater than or equal to “70 km/h” according to MODEL #6, the terminal device 10 outputs a velocity of “75 km/h” as an estimated velocity. On the other hand, in a case where it is determined that an acquired feature amount is a feature amount that is acquired at a time of movement at a velocity less than “70 km/h” according to MODEL #6, the terminal device 10 outputs a velocity of “65 km/h” as an estimated velocity. In a case where MODEL #6 is learning, the terminal device 10 outputs a velocity of “70 km/h” that is a determination velocity of MODEL #6.

As illustrated in FIG. 12, in a case where a moving velocity is estimated by using MODEL #0 to MODEL #6, a velocity capable of being estimated is limited to a range of a velocity less than “80 km/h” as illustrated by (B) in FIG. 12. In general, it is considered that velocity estimation that does not use a GPS or the like is effective in a tunnel or the like that is placed on an expressway or the like. However, in a variation of a model as illustrated in FIG. 12, it may be impossible to estimate a moving velocity greater than or equal to a velocity of “80 km/h”.

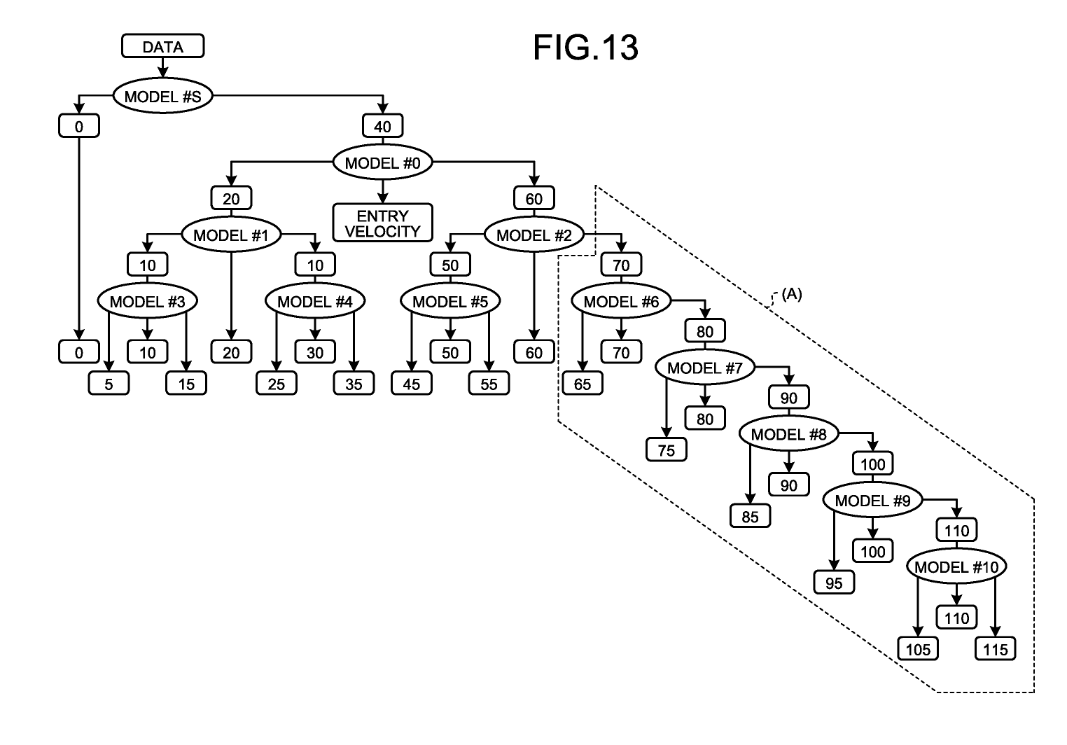

Hence, as illustrated in FIG. 13, the terminal device 10 may use a plurality of models that execute classification based on a high velocity zone. For example, FIG. 13 is a second diagram illustrating a variation of a model that is used by a terminal device according to an embodiment. In an example as illustrated in FIG. 13, the terminal device 10 has MODEL #6 with a determination velocity being a velocity of “70 km/h”, MODEL #7 with a determination velocity being a velocity of “80 km/h”, MODEL #8 with a determination velocity being a velocity of “90 km/h”, MODEL #9 with a determination velocity being a velocity of “100 km/h”, and MODEL#10 with a determination velocity being a velocity of “110 km/h”, in addition to MODEL #0 to MODEL #5 as illustrated by (A) in FIG. 13.

The terminal device 10 can execute a process similar to an estimation process as described above and estimate an estimated velocity from a velocity of “5 km/h” to a velocity of “115 km/h” at an interval of a velocity of “5 km/h” by sequentially using MODEL #6 to MODEL #10. However, running of a general car has a few opportunities to run in a high velocity range (for example, at a velocity greater than or equal to “60 km/h”), and hence, learning data in a high velocity range is reduced. As a result, while accuracy of a model that executes determination of a high velocity range is degraded, an opportunity of determination by a model is increased with increasing a moving velocity of a car, so that an estimated velocity of a car is readily estimated to be lower. It is expected that estimation of a moving velocity of a car in a state where it is not possible to use a GPS is mainly executed in a case where a car runs at a lower velocity, such as a case of a traffic jam generated in a tunnel.

Hence, as illustrated in FIG. 1, in a case where it is determined that an acquired feature amount is a feature amount that is produced in a velocity zone greater than a predetermined upper limit velocity, the terminal device 10 provides a moving velocity measured immediately before it becomes impossible to use a GPS (that is, a tunnel entry velocity) as an estimated velocity. As a result, the terminal device 10 can prevent accuracy of an estimated velocity from being reduced at a time of movement in a high velocity range.

In a state where there are comparatively many opportunities to run in a high velocity range and learning data in a high velocity range can sufficiently be acquired, it is expected that an estimated velocity in a high velocity range can be estimated accurately, even in a case where a model as illustrated in FIG. 13 is used. Hence, for example, in a case where a car runs on a road with no speed limit (such as the autobahn), the terminal device 10 may execute an estimation process that uses a model that executes classification in a high velocity range as illustrated in FIG. 13.

4-2. For Interval of Estimated Velocity

In the process as described above, the terminal device 10 sets a range of a determination velocity at a velocity of “10 km/h”, and thereby, estimates an estimated velocity from a velocity of “5 km/h” to a velocity of “60 km/h” at an interval of a velocity of “5 km/h”. However, an embodiment is not limited thereto. For example, the terminal device 10 may set a range of a determination velocity of each model at a velocity of “20 km/h”, and thereby, estimate an estimated velocity in units of a velocity of “10 km/h”. The terminal device 10 may set a range of a determination velocity of each model at a velocity of “2 km/h”, and thereby, estimate an estimated velocity in units of a velocity of “1 km/h”. That is, the terminal device 10 may execute estimation of an estimated velocity in units of any velocity range.

Although learning data is capable of being acquired at a time of running of a car, a deviation may exist in a velocity zone with learning data being acquired therefrom. For example, a moving velocity of a car is frequently included in a comparatively low velocity range. Hence, the terminal device 10 may change, for each velocity zone, a range of an estimated velocity depending on an amount of acquired learning data. That is, in a case where a moving velocity that is included in a predetermined fourth velocity zone is measured more frequently than a moving velocity that is included in a predetermined third velocity zone at a time when learning data are collected, the terminal device 10 causes a range of a velocity zone that is classified by a model that learns a velocity zone that is included in a third velocity zone to be greater than a range of a velocity zone that is classified by a model that learns a velocity zone that is included in a fourth velocity zone.

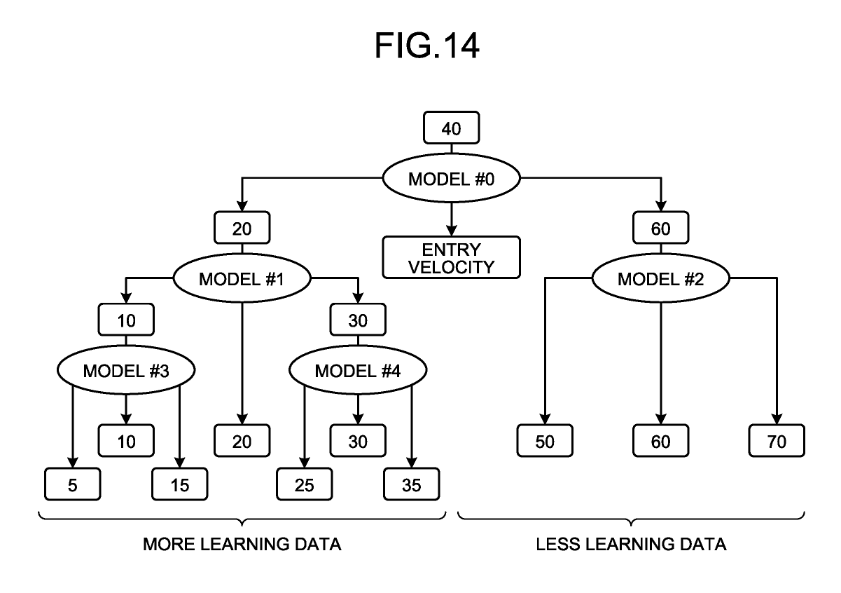

For example, FIG. 14 is a third diagram illustrating a variation of a model that is used by a terminal device according to an embodiment. In an example as illustrated in FIG. 14, an example is described where an amount of learning data acquired at a velocity less than “40 km/h” is greater than an amount of learning data acquired at a velocity greater than or equal to “40 km/h”. Thus, in a case where a deviation exists in an amount of learning data at a velocity of “40 km/h” as a boundary, the terminal device 10 can prevent degradation of accuracy of estimation of a moving velocity in a velocity range less than a velocity of “40 km/h”, even in a case where a model is caused to learn in such a manner that a velocity range less than a velocity of “40 km/h” is classified finely. However, in a case where a model is caused to learn in such a manner that a velocity range greater than or equal to a velocity of “40 km/h” is classified finely, accuracy of estimation of a moving velocity in a velocity range greater than or equal to a velocity of “40 km/h” may be degraded.

Hence, as illustrated in FIG. 14, the terminal device 10 changes a range of an estimated velocity between a velocity range less than a velocity of “40 km/h” and a velocity range greater than or equal to a velocity of “40 km/h”. More specifically, the terminal device 10 executes learning of MODEL #1, MODEL #3, and MODEL #4, in such a manner that classification is executed in units of a velocity of “50 km/h” in a velocity range less than a velocity of “40 km/h”. On the other hand, the terminal device 10 executes only learning of MODEL #2 that executes classification in units of a velocity of “10 km/h” in a velocity range greater than or equal to a velocity of “40 km/h”. As a result, even in a case where an amount of learning data in a velocity range greater than or equal to a velocity of “40 km/h” is small, the terminal device 10 increases a range of an estimated velocity, and thereby, can prevent degradation of accuracy of estimation.

The terminal device 10 may count, for each velocity zone, the number of learning data collected within a predetermined period of time, at a time of learning of a model, and execute a process of causing a range of an estimated velocity to be greater than a predetermined range for a velocity zone with the counted number being less than a predetermined threshold. The terminal device 10 may count, for each velocity zone, the number of all learning data having ever been acquired, at a time of learning of a model, and execute a process of causing a range of an estimated velocity to be greater than a predetermined range for a velocity zone with the counted number being less than a predetermined threshold.

4-3. For Feature Amount

In the description as provided above, the terminal device 10 transforms acceleration in a terminal coordinate system detected by the acceleration sensor 13 into acceleration in an estimation coordinate system, acquires a feature amount from acceleration after transformation, and executes estimation of a moving velocity or learning of a model by using the acquired feature amount. However, an embodiment is limited thereto. For example, the terminal device 10 may acquire a feature amount from acceleration in a terminal coordinate system that is detected by acceleration sensor 13, use the acquired feature amount as learning data of each velocity estimation model, input a feature amount acquired from acceleration in a terminal coordinate system to each velocity estimation model, and execute estimation of a moving velocity. The terminal device 10 may directly input acceleration in an estimation coordinate system or acceleration in a terminal coordinate system for learning of a velocity estimation model or as data to be inputted to a velocity estimation model.

Herein, it is considered that each velocity estimation model learns a feature of information that indicates a moving state of a car and changes depending on a moving velocity of the car, so that estimation of a moving velocity can be executed. Hence, the terminal device 10 may detects a physical state that is produced at a time of movement of a car and estimate a moving velocity of a car by using a model that has learned a velocity zone with such a physical state being produced therefrom. For example, the terminal device 10 collects sound (for example, wind noise) or the like that is generated inside a car or outside the car, by using a sound collection device such as a microphone. The terminal device 10 may execute learning of a model that estimates a velocity zone from sound or a feature amount of the sound by using collected sound or a feature amount of the collected sound, and a velocity at a time where such sound or a feature amount is acquired, as learning data, and execute estimation of a moving velocity. The terminal device 10 can adopt any physical state that indicates a moving state of a car other than acceleration or sound.

4-4. For Change of Model

Herein, it is considered that acceleration of vibration or the like that is caused at a time when a car runs is changed depending on various factors. For example, it is expected that acceleration that is caused at a time when a car runs is changed depending on a physical state of a movable body, such as a kind of a car that is a target for estimation of a moving velocity, a kind of a tire such as a studless tire or a normal tire, whether or not a tire chain is attached, or whether a tire chain is made of resin or metal. It is expected that acceleration that is caused at a time when a car runs is also changed depending on weather, presence or absence of rainfall, a degree of rainfall, whether or not it is an icy road, a pavement state such as age or material of a pavement of a road with a car running, or the like. It is considered that a pavement state of a road is changed depending on a road or a position where a car moves, whether a car runs on an inbound lane or an outbound lane, a section where a car moves, or the like.

Hence, the terminal device 10 may preliminarily learn a plurality of models dependent on a physical state of a movable body, a state of a road where a movable body runs, or the like, and improve accuracy of estimation of a moving velocity by using a model dependent on a physical state of a movable body, a state of a road where a movable body runs, or the like. For example, the terminal device 10 may change a model to be used, depending on at least one of a section where a car moves, a state of a road surface where a car moves, a kind of a car, whether on a section where a car moves, a kind of a tire that is used by a car, and the like.

For example, the terminal device 10 may prepare a plurality of sets of a plurality of velocity estimation models for estimating a moving velocity, execute learning dependent on a kind of a car, weather, or the like for each set, or adopt different learning coefficients. For the terminal device 10 may estimate a moving velocity by using a set of velocity estimation models that correspond to an inbound lane at a section in a case of running on the inbound lane at the section, or estimate a moving velocity by using a set of velocity estimation models that correspond to an outbound lane at a section in a case of running on the outbound lane at a section identical thereto.

4-5. Use of General-Purpose Model

Herein, the terminal device 10 may execute a start-up of an application that includes a general-purpose model in order to be able to execute stop determination at a time of a start-up, even at a time of an initial start-up of an application that realizes a process as described above. For example, in a case where such an application is executed, the terminal device 10 executes an estimation process by using a general-purpose model at a time of an initial start-up and executes an estimation process by using a model learned for the terminal device 10. The terminal device 10 executes correction learning of a general-purpose model by using learning data acquired at a time of running of a car.

As a result, the terminal device 10 can realize an estimation process at certain accuracy from a time of a start of use thereof and can improve accuracy of estimation with time. The terminal device 10 executes an estimation process by using a general-purpose model learned for a kind of a car or a kind of a tire that is used by a car. The terminal device 10 may uploads onto a predetermined server, and redistribute in a usable state by another terminal device, a velocity estimation model learned from a general-purpose model.

4-6. For Learning Mode

Herein, the terminal device 10 may acquire a velocity by using a GPS or may acquire a moving velocity from a control device that is included in a car, through an OBD or the like, at a time when learning data are collected. For example, in a case where the terminal device 10 is mounted on a car capable of acquiring a moving velocity through an OBD, a moving velocity is acquired through the OBD and learning of each model is executed. In a case where the terminal device 10 is mounted on a car that may be unable to acquire a velocity of a car through an OBD, such as a rental car or a car of a friend of a user, a moving velocity may be estimated by using a learned model at a time when it becomes impossible to use a GPS. That is, the terminal device 10 may execute construction of each model by using learning data that use an OBD or the like and execute an estimation process by using the constructed model in a case where it may be impossible to acquire a velocity of a car through an OBD, a GPS, or the like.

In the description as provided above, the terminal device 10 executes a learning process in order from a velocity estimation model with a value of a “HIERARCHY” being small. That is, the terminal device 10 executes learning of a velocity estimation model in order of decreasing a possibility of being used in an estimation process (in an order decreasing priority and increasing a determination velocity). As a result, in a case where learning of all of velocity estimation models has not been completed, the terminal device 10 can also estimate a moving velocity at certain accuracy. However, an embodiment is not limited thereto. For example, the terminal device 10 may execute learning of respective velocity estimation models in parallel.

The terminal device 10 may execute collection of learning data for each velocity zone, and starts learning of a velocity estimation model with a determination velocity being included in a velocity zone with the number of learning data being greater than a predetermined threshold in a case where the velocity zone exists. That is, the terminal device 10 may execute learning in order from a velocity estimation model with learning data to be used for learning being acquired sufficiently. In a case where such a learning process is executed, the terminal device 10 estimates a moving velocity by using a velocity estimation model in a velocity zone with learning data being collected sufficiently, or may execute estimation of a moving velocity without using a velocity estimation model in a velocity zone with learning data having not sufficiently been collected. For example, the terminal device 10 may estimate a moving velocity based on history of an estimated velocity that has ever been estimated.

The terminal device 10 may collect learning data in a predetermined mode. For example, even in a case where an application that provides a guiding process is canceled, the terminal device 10 may collect learning data as long as it is possible to collect learning data, may use learning data collected by various users, or may use learning data collected by a terminal device that is used by a fellow passenger. For example, the terminal device 10 may set an initial period of time for executing a learning process, execute learning of each model during such an initial period of time, and execute an estimation process that uses each learned model after a lapse of the initial period of time.

The terminal device 10 may output each learned model availably as a model that is used for automated driving. In a case where automated driving becomes popular, it is expected that an average moving velocity of a car is greater than a current average moving velocity. As illustrated in FIG. 13, the terminal device 10 may learn a plurality of velocity estimation models for executing determination in an asymmetrical mode centered on a predetermined determination velocity. More specifically, the terminal device 10 may use a velocity estimation model with learning of a velocity zone having been executed at a higher speed, more frequently.

The terminal device 10 may execute, for example, learning of a velocity estimation model for determining whether or not an input feature amount is included in a predetermined velocity zone or estimation of an estimated velocity that uses such a velocity estimation model. For example, the terminal device 10 executes learning of a velocity estimation model for determining whether or not a velocity zone with a detected feature amount being able to be produced therein is included in a velocity zone from a velocity of “40 km/h” to a velocity of “50 km/h”. In a case where it is determined that a velocity zone with an acquired feature amount being produced therein is included in a velocity zone from a velocity of “40 km/h” to a velocity of “50 km/h”, based on such velocity estimation model, the terminal device 10 may provide a velocity of “45 km/h” as an estimated velocity.

4.7 For Model

In the description as provided above, the terminal device 10 executes learning of an SVM as a stop determination model or a velocity estimation model. However, an embodiment is not limited thereto. For example, the terminal device 10 may use learning of a neural network or learning referred to as so-called deep learning. As a specific example is provided, the terminal device 10 may execute learning of a neural network such as a Deep Neural Network (DNN) that executes stop determination, by using learning data.

4-8. For Process Interval

The terminal device 10 as described above executes an estimation process or a learning process, for example, at an interval of 1 second. However, an embodiment is not limited thereto, and an estimation process or a learning process may be executed at ant timing. For example, the terminal device 10 may execute measurement of a moving velocity by using a GPS, constantly execute estimation of a moving velocity that uses a model, and execute a learning process in a case where a percentage of a correct answer is less than a predetermined threshold.

4-9. For Attitude Change

Herein, the terminal device 10 may identify an attitude of the terminal device 10. For example, in a case where acceleration within a certain period of time is averaged, a direction of an average vector G thereof is identical to a direction of gravity acceleration. For example, in a case where a direction of an average vector of all of acceleration that has ever been measured from a start-up of an application and a direction of an average vector of acceleration detected for a last 1 second are compared and there is an angular difference greater than or equal to 37 degrees (that is, a case where a cosine value of an angle between respective average vectors is less than 0.8), the terminal device 10 may determine that an attitude of the terminal device 10 is changed.

In a case where it is determined that there is such an attitude change, the terminal device 10 deletes learning data registered in the learning data database 12b or each model registered in the model database 12d, and executes collection of new learning data or learning of a model. As a result, the terminal device 10 can reduce degradation of accuracy of determination in a case where an attitude change is caused. 4-10. Other Embodiments

The embodiment as described above is merely illustration and the present embodiment also includes those illustrated below and embodiments other than them. For example, a functional configuration, a data configuration, an order and content of processes illustrated in a flowchart, and the like in the present application are merely illustration, and presence or absence of each element, arrangement thereof, an order or specific content of execution of processes, or the like, is changeable appropriately. For example, the guiding process or estimation process as described above can also be realized as a device, a method, or a program in a terminal that is realized by an application of a smartphone or the like, other than those realized by the terminal device 10 as illustrated in the embodiment as described above.

It is also common that a configuration is provided in such a manner that the respective processing units 17 to 20 that constitute the terminal device 10 are further realized by mutually independent devices. A configuration may be provided in such a manner that the respective units 20 to 25 that constitute the moving state estimation unit 20 are realized by mutually independent devices. Similarly, a configuration of the present embodiment can flexibly be changed by, for example, calling an external platform or the like through an Application Program Interface (API) or network computing (so-called cloud or the like) to realize each means as illustrated in the embodiment as described above. Each element such as a means that is relevant to the present embodiment is not limited to an operation control unit of a computer but may be realized by another information processing mechanism such as a physical electronic circuit.

For example, the terminal device 10 may execute the guiding process as described above, by cooperating the terminal device 10 with a distribution server communicable therewith. For example, a distribution server may include the collection unit 26, the learning unit 27, and the updating unit 28, collect a feature amount from acceleration detected by the terminal device 10, execute learning of a model by using the collected feature amount, and distribute the learned model to the terminal device 10. Such a distribution server may execute learning of each model for each terminal device with learning data having been collected therein, or execute learning of each model for a state such as a kind of a car the terminal device 10 being installed at a time when learning data are collected, a kind of a tire, or a state of a road surface or weather. In a case where such learning is executed, a distribution server may distribute a model dependent on a state at a time when the terminal device 10 executes an estimation process, among learned models, to the terminal device 10.

A distribution server may include the detection unit 21, the setting unit 22, the transformation unit 23, the acquisition unit 24, and the estimation unit 25, distribute an estimated moving velocity to the terminal device 10 based on a value of acceleration detected by the terminal device 10, and execute guiding for a user. A distribution may execute the estimation process as described above, instead of the terminal device 10, and transmit a result of execution to the terminal device 10, to execute a guiding process to the terminal device 10.

In a case where a plurality of terminal devices exist that execute a guiding process or an estimation process in cooperation with a distribution server, a distribution server may determine whether or not each terminal device is moving, by using a different SVM for each terminal device. A distribution server may collect positional information acquired by each terminal device through a GPS, determine whether or not each terminal device is moving, from the collected positional information, and realize learning of an SVM by using a result of determination and a value of acceleration collected from each terminal device.

5. Advantageous Effect

As described above, the terminal device 10 detects a predetermined physical state that is produced at a time of movement. Then, the terminal device 10 estimates a moving velocity from a state detected by a detection unit, by using a learner such as a velocity estimation model that has learned a velocity zone with the physical state being produced therefrom. Hence, the terminal device 10 can estimate a moving velocity based on a feature of a physical state, for example, vibration that is produced at a time of running or the like. As a result, the terminal device 10 can estimate a moving velocity accurately even in a case where an installation attitude of the terminal device 10 is unclear.

Furthermore, the terminal device 10 estimates a moving velocity from a state detected by the detection unit, by using, as the learner, a plurality of learners that have learned velocity zones with the physical state being produced therefrom and being mutually different velocity zones. Thus, in a case where a plurality of models are caused to learn mutually different velocity zones, accuracy of determination for each model can be improved. Hence, the terminal device 10 can further improve accuracy of estimation of a moving velocity.

Furthermore, the terminal device 10 estimates the moving velocity from a detected state, by using, as the plurality of learners, a plurality of learners that determine whether or not a velocity zone with the physical state being produced therefrom is a predetermined velocity zone, in a stepwise manner. Hence, the terminal device 10 can reduce the number of times that a velocity zone is estimated by using a model, and hence, can reduce a calculation resource in an estimation process.

Furthermore, the terminal device 10 estimates a velocity zone with a detected state being produced therefrom, by using, in a case where a first learner that determines whether or not a velocity zone with the physical state being produced therefrom is a predetermined first velocity zone determines that a velocity zone with a detected state being produced therefrom is the first velocity zone, a second learner that determines whether or not a velocity zone with the physical state being produced therefrom is a second velocity zone that is included in the first velocity zone. Thus, the terminal device 10 limits a velocity zone in a stepwise manner, and hence, can reduce a calculation resource in an estimation process and can estimate a moving velocity at certain accuracy, even in a case where learning of all models has not been completed.

Furthermore, the terminal device 10 estimates the moving velocity, by preferentially using a learner that determines whether or not it is a velocity zone with more opportunities to move than those of another velocity zone, among the plurality of learners. Hence, the terminal device 10 can improve accuracy of an estimated velocity in a general moving state.

Furthermore, the terminal device 10 estimates the moving velocity, by using, as the learner, a learner that determines whether a velocity zone with the physical state being produced therefrom is a velocity zone greater than a predetermined velocity or a velocity zone less than the predetermined velocity. Furthermore, the terminal device 10 estimates, by using the leaner, a velocity zone with a detected state being produced therefrom, and outputs, as a result of estimation, a moving velocity that is included in an estimated velocity zone. Hence, the terminal device 10 can estimate a moving velocity from a physical state.

Furthermore, the terminal device 10 outputs, as the moving velocity, a velocity that is last measured by a predetermined measurement means, in a case where a velocity zone with a detected state being produced therefrom is estimated to be a velocity zone greater than a predetermined upper limit velocity by using the learner. Hence, the terminal device 10 can prevent degradation of accuracy of estimation that is caused by an increase of the number of times of determination that uses a velocity estimation model and estimate a moving velocity.

Furthermore, the terminal device 10 outputs, as a result of estimation, an average of estimated velocities that are estimated within a predetermined period of time in a case where a difference between a previously estimated moving velocity and a newly estimated moving velocity falls within a predetermined range. On the other hand, the terminal device 10 outputs, as a newly estimated velocity, a value provided by adding to or subtracting from a previously estimated moving velocity, a predetermined value, in a case where a difference between a previously estimated moving velocity and a newly estimated moving velocity does not fall within a predetermined range. Hence, the terminal device 10 can prevent an actually impossible change of an estimated velocity.

Furthermore, the terminal device 10 acquires a feature amount that indicates a feature of a detected state, and estimates a moving velocity from a detected state by using, as the learner, a learner that has learned a velocity zone with the feature amount being acquired therefrom. Furthermore, the terminal device 10 acquires, as the feature amount, at least one of an average, a maximum, a minimum, and a standard deviation of states detected by a detection unit. Hence, the terminal device 10 can improve accuracy of an estimated velocity by a learner.

Furthermore, the terminal device 10 detects, as a predetermined physical state that is produced at a time of movement, detected acceleration or a measured sound. Hence, the terminal device 10 can estimate a moving velocity based on vibration of a car, wind noise, or the like.

Furthermore, the terminal device 10 changes a learner that is used at a time when the moving velocity is estimated, depending on at least one of a section where a movable body with a moving velocity to be estimated moves, a state of a road surface where the movable body moves, a kind of the movable body, weather on a section where the movable body moves, and a kind of a tire that is used for the movable body. Hence, the terminal device 10 can improve accuracy of an estimated velocity that uses a velocity estimation model.

Furthermore, the terminal device 10 causes a learner that learns a velocity zone with the detected state being detected therein to learn, by using, in a case where the moving velocity can be measured by a predetermined measurement means, a set of a detected state and a measured moving velocity. Then, the terminal device 10 estimates the moving velocity by using the learner caused to learn. Hence, the terminal device 10 can improve accuracy of learning of a velocity estimation model.

Furthermore, the terminal device 10 causes a plurality of learners to learn, in an order dependent on a velocity zone to be learned, and estimates the moving velocity by using the plurality of learns in a stepwise manner in an order of learning to be executed by the learning unit. Furthermore, the terminal device 10 causes a learner that learns a velocity zone with more opportunities to move, among the plurality of learners, to learn preferentially. More specifically, the terminal device 10 causes, in a case where a moving velocity that is included in a fourth velocity zone is measured more frequently than a moving velocity that is included in a third velocity zone at a time when the state is detected, a range of a velocity zone that is learned by a learner that learns a velocity zone that is included in the third velocity zone to be greater than a range of a velocity zone that is learned by a learner that learns a velocity zone that is included in the fourth velocity zone. Hence, the terminal device 10 can prevent degradation of accuracy of estimation that is caused by a lack of learning data.

A “section, module, or unit” as has been described above can be read as a “means”, a “circuit”, or the like. For example, the moving state estimation unit can be read as a moving state estimation means or a moving state estimation circuit.

According to an aspect of an embodiment, an advantageous effect is provided in such a manner that accuracy of estimation of a moving velocity can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An estimation device, comprising:
a detection unit that detects a predetermined physical state that is produced at a time of movement; and
an estimation unit that estimates a moving velocity from a state detected by the detection unit, by using a learner that has learned a velocity zone with the physical state being produced therefrom.

2. The estimation device according to claim 1, wherein the estimation unit estimates a moving velocity from a state detected by the detection unit, by using a plurality of learners that have learned velocity zones with the physical state being produced therefrom and being mutually different velocity zones.

3. The estimation device according to claim 2, wherein the estimation unit estimates the moving velocity from a state detected by the detection unit, by using a plurality of learners that determine whether or not a velocity zone with the physical state being produced therefrom is a predetermined velocity zone, in a stepwise manner.

4. The estimation device according to claim 3, wherein the estimation unit estimates a velocity zone with a state detected by the detection unit being produced therefrom, by using a second learner, in a case where a first learner that determines whether or not a velocity zone with the physical state being produced therefrom is a predetermined first velocity zone determines that a velocity zone with a state detected by the detection unit being produced therefrom is the first velocity zone, that determines whether or not a velocity zone with the physical state being produced therefrom is a second velocity zone that is included in the first velocity zone.

5. The estimation device according to claim 2, wherein the estimation unit estimates the moving velocity, by preferentially using a learner that determines whether or not a velocity zone with the physical state being produced therefrom is a velocity zone with more opportunities to move than those of another velocity zone, among the plurality of learners.

6. The estimation device according to claim 1, wherein the estimation unit estimates the moving velocity, by using a learner that determines whether a velocity zone with the physical state being produced therefrom is a velocity zone greater than a predetermined velocity or a velocity zone less than the predetermined velocity.

7. The estimation device according to claim 1, wherein the estimation unit estimates, by using the leaner, a velocity zone with a state detected by the detection unit being produced therefrom, and outputs a moving velocity that is included in an estimated velocity zone as a result of estimation.

8. The estimation device according to claim 1, wherein the estimation unit outputs, as the moving velocity, a velocity that is last measured by a predetermined measurement means, in a case where a velocity zone with a state detected by the detection unit being produced therefrom is estimated to be a velocity zone greater than a predetermined upper limit velocity by using the learner.

9. The estimation device according to claim 1, wherein the estimation unit outputs, as a result of estimation, an average of estimated velocities that are estimated within a predetermined period of time in a case where a difference between a previously estimated moving velocity and a newly estimated moving velocity falls within a predetermined range.

10. The estimation device according to claim 1, wherein the estimation unit outputs, as a result of estimation, a moving velocity provided by adding a predetermined value to a value of a moving velocity estimated in a past or a moving velocity provided by subtracting a predetermined value from a value of a moving velocity estimated in a past, in a case where a difference between a previously estimated moving velocity and a newly estimated moving velocity does not fall within a predetermined range.

11. The estimation device according to claim 1, further comprising:
an acquisition unit that acquires a feature amount that indicates a feature of a state detected by the detection unit, wherein
the estimation unit estimates a moving velocity from a state detected by the detection unit by using, as the learner, a learner that has learned a velocity zone with the feature amount being acquired therefrom.

12. The estimation device according to claim 11, wherein the acquisition unit acquires, as the feature amount, at least one of an average, a maximum, a minimum, and a standard deviation of states detected by the detection unit.

13. The estimation device according to claim 1, wherein the detection unit detects, as a predetermined physical state that is produced at a time of movement, acceleration measured by a terminal device installed in a movable body or a sound measured by the terminal device.

14. The estimation device according to claim 1, wherein the estimation unit changes a learner that is used at a time when the moving velocity is estimated, depending on at least one of a section where a movable body with a moving velocity to be estimated moves, a state of a road surface where the movable body moves, a kind of the movable body, weather on a section where the movable body moves, and a kind of a tire that is used for the movable body.

15. The estimation device according to claim 1, further comprising:
a learning unit that causes a learner that learns a velocity zone with the detected state being detected therein to learn, by using, in a case where the moving velocity can be measured by a predetermined measurement means, a set of a state detected by the detection unit and a measured moving velocity, wherein
the estimation unit estimates the moving velocity by using the learner caused to learn by the learning unit.

16. The estimation device according to claim 15, wherein:
the learning unit causes a plurality of learners to learn, in an order dependent on a velocity zone to be learned; and
the estimation unit estimates the moving velocity by using the plurality of learns in a stepwise manner in an order of learning to be executed by the learning unit.

17. The estimation device according to claim 16, wherein
the learning unit causes a learner that learns a velocity zone with more opportunities to move, among the plurality of learners, to learn preferentially.

18. The estimation device according to claim 15, wherein the learning unit causes, in a case where a moving velocity that is included in a fourth velocity zone is measured more frequently than a moving velocity that is included in a third velocity zone at a time when the state is detected, a range of a velocity zone that is learned by a learner that learns a velocity zone that is included in the third velocity zone to be greater than a range of a velocity zone that is learned by a learner that learns a velocity zone that is included in the fourth velocity zone.

19. An estimation method that is executed by an estimation device, comprising:
detecting a predetermined physical state that is produced at a time of movement; and
estimating a moving velocity from a state detected by the detecting, by using a learner that has learned a velocity zone with the physical state being produced therefrom.

20. A non-transitory computer-readable recording medium having stored therein an estimation program that causes a computer to execute a process comprising:
detecting a predetermined physical state that is produced at a time of movement; and
estimating a moving velocity from a state detected by the detecting, by using a learner that has learned a velocity zone with the physical state being produced therefrom.
